(19) United States
(12) Patent Application Publication
(10) Pub. No.: US 2020/0243903 A1
(43) Pub. Date: Jul. 30, 2020

(54) SOLID ELECTROLYTE COMPOSITION, SOLID ELECTROLYTE-CONTAINING SHEET, ALL-SOLID STATE SECONDARY BATTERY, AND METHODS FOR MANUFACTURING SOLID ELECTROLYTE-CONTAINING SHEET AND ALL-SOLID STATE SECONDARY BATTERY

(71) Applicant: FUJIFILM Corporation, Tokyo (JP)

(72) Inventors: Yo KUSHIDA, Kanagawa (JP); Masaomi MAKINO, Kanagawa (JP); Hiroaki MOCHIZUKI, Kanagawa (JP); Tomonori MIMURA, Kanagawa (JP)

(73) Assignee: FUJIFILM Corporation, Tokyo (JP)

(21) Appl. No.: 16/846,425

(22) Filed: Apr. 13, 2020

Related U.S. Application Data
(63) Continuation of application No. PCT/JP2018/038269, filed on Oct. 15, 2018.

(30) Foreign Application Priority Data
Oct. 30, 2017 (JP) 2017-209602

(51) Int. Cl. H01M 10/0562; H01M 10/0525; H01M 10/0569; H01M 4/62; H01M 4/1391; H01M 4/1395; H01M 4/60; H01M 4/66

(52) U.S. Cl. CPC H01M 10/0562; H01M 10/0525; H01M 10/0569; H01M 4/622; H01M 2004/021; H01M 4/1395; H01M 4/608; H01M 4/667; H01M 4/1391

(57) ABSTRACT

A solid electrolyte composition includes an inorganic solid electrolyte (A) having ion conductivity of a metal belonging to Group I or II of the periodic table, a binder (B), a dispersion medium (C), and a solvent (D) having any one of a fluorine atom, an oxygen atom, a nitrogen atom, or a chlorine atom in a chemical structure, in which a polymer constituting the binder (B) has a partial structure including an acyclic siloxane structure represented by General Formula (I) and a partial structure represented by General Formula (II). A solid electrolyte-containing sheet has a layer constituted of the solid electrolyte composition. The all-solid state secondary battery includes the solid electrolyte-containing sheet. Methods for manufacturing a solid electrolyte-containing sheet and an all-solid state secondary battery include a step of applying the solid electrolyte composition onto a base material.

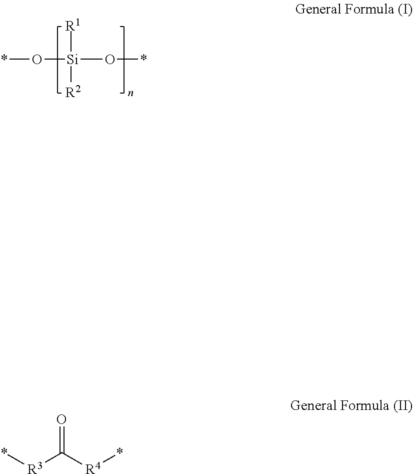

### CROSS-REFERENCE TO RELATED APPLICATIONS

This application is a Continuation of PCT International Application No. PCT/JP2018/038269 filed on Oct. 15, 2018, which claims priority under 35 U.S.C § 119(a) to Japanese Patent Application No. 2017-209602 filed on Oct. 30, 2017. Each of the above application(s) is hereby expressly incorporated by reference, in its entirety, into the present application.

### BACKGROUND OF THE INVENTION

### 1. Field of the Invention

The present invention relates to a solid electrolyte composition, a solid electrolyte-containing sheet, an all-solid state secondary battery, and methods for manufacturing a solid electrolyte-containing sheet and an all-solid state secondary battery.

### 2. Description of the Related Art

A lithium ion secondary battery is a storage battery which has a negative electrode, a positive electrode, and an electrolyte sandwiched between the negative electrode and the positive electrode and enables charging and discharging by the reciprocal migration of lithium ions between both electrodes. In the related art, in lithium ion secondary batteries, an organic electrolytic solution has been used as the electrolyte. However, in organic electrolytic solutions, liquid leakage is likely to occur, there is a concern that a short circuit and ignition may be caused in batteries due to overcharging or overdischarging, and there is a demand for additional improvement in safety and reliability.

Under such circumstances, all-solid state secondary batteries in which an inorganic solid electrolyte is used instead of the organic electrolytic solution are attracting attention. In all-solid state secondary batteries, all of the negative electrode, the electrolyte, and the positive electrode are solid, safety and reliability which are considered as a problem of batteries in which the organic electrolytic solution is used can be significantly improved, and it also becomes possible to extend the service lives. Furthermore, all-solid state secondary batteries can be provided with a structure in which the electrodes and the electrolyte are directly disposed in series. Therefore, it becomes possible to increase the energy density to be higher than that of secondary batteries in which the organic electrolytic solution is used, and thus the application to electric vehicles, large-sized storage batteries, and the like is anticipated.

Due to the respective advantages described above, research and development for practical use of an all-solid state secondary batteries as next-generation lithium ion batteries is actively underway. So far, a solid electrolyte composition containing a specific binder has been reported as a layer constituent material of an all-solid state secondary battery in order to improve the performance of the all-solid state secondary battery. For example, JP2016-031868A describes a solid electrolyte composition containing a polymer having a cage-like silsesquioxane skeleton in a side chain and an inorganic solid electrolyte having ion conductivity of a metal belonging to Group I or II of the periodic table. An all-solid state secondary battery produced using this solid electrolyte composition is said to have excellent moisture resistance, high ion conductivity, and excellent temporal stability of ion conductivity. In addition, a solid electrolyte composition containing a binder and a specific solvent has been reported as a layer constituent material of an all-solid state secondary battery. For example, JP2010-212058A describes a solid electrolyte composition containing a sulfide-based inorganic solid electrolyte, a binding agent polymer, and a solvent constituted of a compound that does not contain a polar group that reacts with a sulfide in the molecular structure. JP2010-212058A describes that a reaction between a solvent and a sulfide-based inorganic solid electrolyte are suppressed, and thus a decrease in lithium ion conductivity is suppressed in the all-solid state secondary battery produced using the solid electrolyte composition.

### SUMMARY OF THE INVENTION

For the practical use of all-solid state secondary batteries, it is desired to improve the battery performance such as ion conductivity and the yield of all-solid state secondary batteries. In the manufacture of an all-solid state secondary battery using a slurry of a solid electrolyte composition, usually, the slurry is applied and dried to form a solid electrolyte layer and/or an electrode active material layer, or a laminate thereof, and then pressurization is performed (for example, 350 MPa). However, the solid electrolyte layer or the electrode active material layer formed using the slurry may be cracked by this pressurization, and an all-solid state secondary battery having desired performance may not be obtained. Therefore, a solid electrolyte layer or an electrode active material layer is required to have a mechanical strength that can withstand the above-mentioned pressurization.

An object of the present invention is to provide a solid electrolyte composition that can impart not only excellent mechanical strength to a solid electrolyte layer and/or an electrode active material layer which constitute a solid electrolyte-containing sheet obtained by using the solid electrolyte layer and/or the electrode active material layer as a layer constituent material of the solid electrolyte-containing sheet but also high ion conductivity to the solid electrolyte-containing sheet. In addition, another object of the present invention is to provide a solid electrolyte-containing sheet obtained by using the solid electrolyte composition described above and an all-solid state secondary battery using the solid electrolyte-containing sheet. Further, another object of the present invention is to provide methods for manufacturing the solid electrolyte-containing sheet and the all-solid state secondary battery.

As a result of extensive studies, the present inventors have found that, by using a solid electrolyte composition containing a specific inorganic solid electrolyte, a binder having an acyclic siloxane skeleton as a hydrophobic moiety, a dispersion medium, and a solvent using a compound having a specific atom as the solvent, a solid electrolyte layer and/or an electrode active material layer constituting a solid electrolyte-containing sheet using the solid electrolyte composition as a layer constituent material has excellent mechanical strength, and furthermore, the solid electrolyte-containing sheet has excellent ion conductivity. The present invention has been completed based on these findings.

That is, the above-described problems have been solved by the following means.

<1> A solid electrolyte composition comprising an inorganic solid electrolyte (A) having ion conductivity of a metal belonging to Group I or II of the periodic table, a binder (B), a dispersion medium (C), and a solvent (D) having any one of a fluorine atom, an oxygen atom, a nitrogen atom, or a chlorine atom in a chemical structure, in which a polymer constituting the binder (B) has a partial structure including an acyclic siloxane structure represented by General Formula (I) and a partial structure represented by General Formula (II).

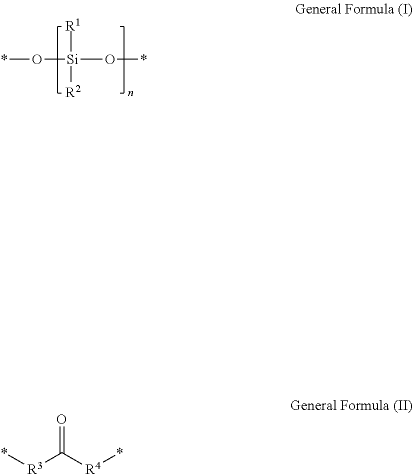

In General Formula (I), R¹ and R² each independently represent a hydrogen atom or a substituent. n represents an integer of 1 or greater. * represents a bonding portion in the polymer constituting the binder (B).

In General Formula (II), R³ and R⁴ each independently represent a divalent linking group. * represents a bonding portion in the polymer constituting the binder (B).

<2> The solid electrolyte composition according to <1>, in which a weight-average molecular weight of the partial structure including the acyclic siloxane structure represented by General Formula (I) is 10,000 or less.

<3> The solid electrolyte composition according to <1> or <2>, in which any one of R¹ or R² in General Formula (I) is a group represented by General Formula (III) or (IV).

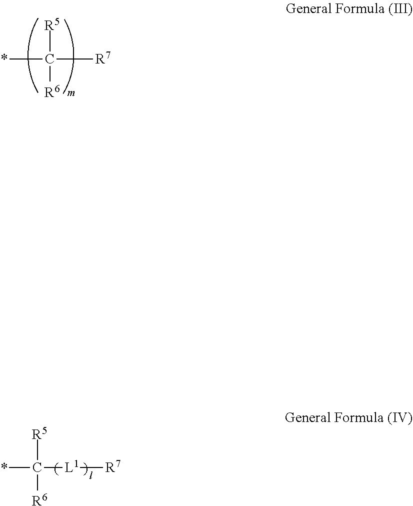

In the formulae, R⁵, R⁶, and R⁷ each independently represent a hydrogen atom or a substituent. m and 1 each independently represent an integer of 1 to 100. L¹ represents a divalent linking group. * represents a bonding portion in the polymer constituting the binder (B).

<4> The solid electrolyte composition according to any one of <1> to <3>, in which the polymer constituting the binder (B) includes a partial structure represented by General Formula (V).

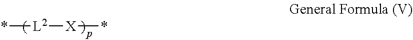

In the formula, L² represents a divalent linking group, X represents any one of —O—, —NR— or —S—. R represents a hydrogen atom or a substituent. p represents an integer of 3 to 300. * represents a bonding portion in the polymer constituting the binder (B).

<5> The solid electrolyte composition according to <4>, in which L² in General Formula (V) is a structure represented by General Formula (VI).

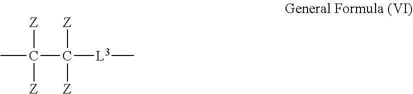

In the formula, Z's each independently represent a hydrogen atom or a substituent. L³ represents a single bond or a divalent linking group.

<6> The solid electrolyte composition according to any one of <1> to <5,> in which at least one of R³ or R⁴ in General Formula (II) represents a divalent hetero atom or a divalent linking group including a hetero atom.

<7> The solid electrolyte composition according to <3>, in which R⁵ or R⁶ in General Formulae (III) and (IV) is an alkyl group having 5 or fewer carbon atoms.

<8> The solid electrolyte composition according to any one of <1> to <7>, in which the polymer constituting the binder (B) has at least one group selected from the group consisting of a hydroxy group, a cyano group, an amino group, and a carboxy group.

<9> The solid electrolyte composition according to <4>, in which the divalent linking group represented by L² in General Formula (V) has an oxygen atom.

<10> The solid electrolyte composition according to any one of <1> to <9>, in which the solvent (D) has a carbonyl group or a sulfonyl group.

<11> The solid electrolyte composition according to any one of <1> to <10>, in which a content of the binder (B) is 0.1 parts by mass or more and 20 parts by mass or less with respect to 100 parts by mass of the inorganic solid electrolyte (A).

<12> The solid electrolyte composition according to any one of <1> to <11>, further comprising an active material (E).

<13> The solid electrolyte composition according to any one of <1> to <12>, further comprising a conductive auxiliary agent (F).

<14> The solid electrolyte composition according to any one of <1> to <13>, in which the inorganic solid electrolyte (A) is a sulfide-based inorganic solid electrolyte.

<15> The solid electrolyte composition according to any one of <1> to <14>, further comprising a lithium salt (G).

<16> A solid electrolyte-containing sheet comprising a layer made of the solid electrolyte composition according to any one of <1> to <15>.

<17> An all-solid state secondary battery comprising a positive electrode active material layer, a negative electrode active material layer, and a solid electrolyte layer, in which at least one layer of the positive electrode active material layer, the negative electrode active material layer, or the solid electrolyte layer is the solid electrolyte-containing sheet according to <16>.

<18> A method for manufacturing the solid electrolyte-containing sheet according to <16>, the method comprising a step of applying the solid electrolyte composition according to any one of <1> to <15> onto a base material.

<19> A method for manufacturing an all-solid state secondary battery, the method comprising manufacturing an all-solid state secondary battery through the manufacturing method according to <18>.

In the description of the present invention, in a case where there are a plurality of substituents and/or linking groups indicated by a specific reference sign or in a case where a plurality of substituents or the like (similarly, also the number of substituents) is defined simultaneously or selectively, the individual substituents or the like may be identical to or different from each other. In addition, in a case where a plurality of substituents or the like is close to each other, the substituents or the like may bond or condense to each other to form a ring.

In the description of the present invention, the weight-average molecular weight (Mw) can be measured as a polystyrene-equivalent molecular weight by GPC unless otherwise specified. In this case, a GPC apparatus HLC-8220 (manufactured by Tosoh Corporation) is used, a column is G3000HXL+G2000HXL, the flow rate is 1 mL/min at 23° C., and the detection is performed by RI. The eluent can be selected from THF (tetrahydrofuran), chloroform, NMP (N-methyl-2-pyrrolidone), and m-cresol/chloroform (manufactured by Shonan Wako Pure Chemical Industries, Ltd.), and THF is used when it is soluble.

In the description of the present invention, the glass transition temperature (Tg) is measured using a dry sample and a differential scanning calorimeter “X-DSC7000” (trade name, manufactured by SII Nanotechnology) using the following conditions unless otherwise specified. The measurement is performed twice for the same sample, and the result of the second measurement is adopted.
Atmosphere in measurement room: Nitrogen (50 mL/min)
Temperature rising rate: 5° C./min
Measurement start temperature: −100° C.
Measurement end temperature: 200° C.
Sample pan: Aluminum pan
Mass of measurement sample: 5 mg
Calculation of Tg: Tg is calculated by rounding off the decimal point of the intermediate temperature between the descent start point and descent end point of the DSC chart.

The solid electrolyte composition of the embodiment of the present invention can impart a high level of mechanical strength to a solid electrolyte layer and/or an electrode active material layer which constitute a solid electrolyte-containing sheet by using the solid electrolyte layer and/or the electrode active material layer as a layer constituent material of the solid electrolyte-containing sheet and high level of ion conductivity to the solid electrolyte-containing sheet. The solid electrolyte-containing sheet and the all-solid state secondary battery of the embodiment of the present invention have a solid electrolyte layer and/or an electrode active material layer having excellent mechanical strength, and have excellent ion conductivity. The solid electrolyte-containing sheet and the all-solid state secondary battery exhibiting excellent characteristics described above can be manufactured using the method for manufacturing the solid electrolyte-containing sheet and the method for manufacturing the all-solid state secondary battery of the present invention.

### BRIEF DESCRIPTION OF THE DRAWINGS

FIG. 1 is a vertical cross-sectional view schematically illustrating an all-solid state secondary battery according to a preferred embodiment of the present invention.

FIG. 2 is a vertical sectional view schematically illustrating a device used in Example.

FIG. 3 is a vertical cross-sectional view schematically illustrating a test specimen for measuring ion conductivity produced in Example.

### DESCRIPTION OF THE PREFERRED EMBODIMENTS

<Solid Electrolyte Composition>

A solid electrolyte composition including an inorganic solid electrolyte (A) having ion conductivity of a metal belonging to Group I or II of the periodic table, a binder (B), and a dispersion medium (C), in which the binder (B) has a partial structure including an acyclic siloxane represented by General Formula (I) and a partial structure represented by General Formula (II) and the dispersion medium (C) contains the solvent (D) having a chemical structure including any one of a fluorine atom, an oxygen atom, a nitrogen atom, or a chlorine atom in a chemical structure.

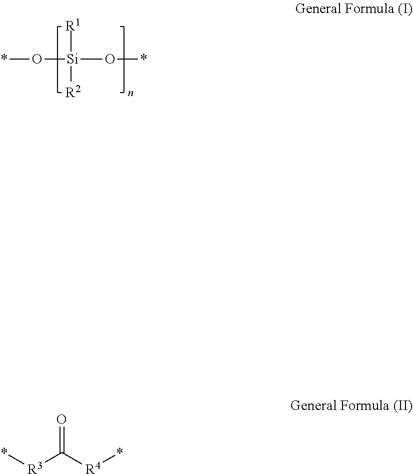

In General Formula (I), R¹ and R² each independently represent a hydrogen atom or a substituent. n represents an integer of 1 or greater. * represents a bonding portion in the polymer constituting a binder (B).

In General Formula (II), R³ and R⁴ each independently represent a divalent linking group. * represents a bonding portion in the polymer constituting a binder (B).

Hereinafter, the “inorganic solid electrolyte (A) having the conductivity of ions of a metal belong to Group I or II of the periodic table” will also be referred to as “inorganic solid electrolyte (A)”. In addition, a component contained in the solid electrolyte composition or a component that may be contained may be described without assigning a reference sign. For example, the inorganic solid electrolyte (A) may be simply referred to as the inorganic solid electrolyte. Further, the binder (B) may be simply referred to as the binder.

(Inorganic Solid Electrolyte (A))

The inorganic solid electrolyte is an inorganic solid electrolyte, and the solid electrolyte refers to a solid-form electrolyte capable of migrating ions therein. The inorganic solid electrolyte is clearly differentiated from organic solid electrolytes (polymer electrolytes represented by polyethylene oxide (PEO) or the like and organic electrolyte salts represented by lithium bis(trifluoromethanesulfonyl)imide (LiTFSI)) since the inorganic solid electrolyte does not include any organic substances as a principal ion-conductive material. In addition, the inorganic solid electrolyte is solid in a static state and thus, generally, is not disassociated or liberated into cations and anions. Due to this fact, the inorganic solid electrolyte is also clearly differentiated from inorganic electrolyte salts of which cations and anions are disassociated or liberated in electrolytic solutions or polymers (LiPF₆, LiBF₄, LiFSI, LiCl, and the like). The inorganic solid electrolyte is not particularly limited as long as the inorganic solid electrolyte has the conductivity of ions of a metal belonging to Group I or II of the periodic table and is generally a substance not having electron conductivity.

In the present invention, the inorganic solid electrolyte has conductivity of ions of a metal belonging to Group I or II of the periodic table. As the inorganic solid electrolyte, it is possible to appropriately select and use solid electrolyte materials that are applied to this kind of product. Typical examples of the inorganic solid electrolyte include (i) sulfide-based inorganic solid electrolytes and (ii) oxide-based inorganic solid electrolytes. In the present invention, the sulfide-based inorganic solid electrolytes are preferably used since it is possible to form a more favorable interface between the active material and the inorganic solid electrolyte.

(i) Sulfide-Based Inorganic Solid Electrolyte

Sulfide-based inorganic solid electrolytes are preferably electrolytes which contain sulfur atoms (S), have ion conductivity of a metal belonging to Group I or II of the periodic table, and have electron-insulating properties. The sulfide-based inorganic solid electrolytes are preferably inorganic solid electrolytes which, as elements, contain at least Li, S, and P and have a lithium ion conductivity, but the sulfide-based inorganic solid electrolytes may also include elements other than Li, S, and P depending on the purposes or cases.

Examples thereof include lithium ion-conductive inorganic solid electrolytes satisfying a composition represented by Formula (I).

Lₐ₁M_{b1}P_{c1}S_{d1}Aₑ₁ Formula (I)

In the formula, L represents an element selected from Li, Na, and K and is preferably Li. M represents an element selected from B, Zn, Sn, Si, Cu, Ga, Sb, Al, and Ge. A represents an element selected from I, Br, Cl, and F. a1 to e1 represent the compositional ratios among the individual elements, and a1:b1:c1:d1:e1 satisfies 1 to 12:0 to 5:1:2 to 12:0 to 10. Furthermore, a1 is preferably 1 to 9 and more preferably 1.5 to 7.5. b1 is preferably 0 to 3. Furthermore, d1 is preferably 2.5 to 10 and more preferably 3.0 to 8.5. Furthermore, el is preferably 0 to 5 and more preferably 0 to 3.

The compositional ratios among the individual elements can be controlled by adjusting the amounts of raw material compounds blended to manufacture the sulfide-based inorganic solid electrolyte as described below.

The sulfide-based inorganic solid electrolytes may be non-crystalline (glass) or crystallized (made into glass ceramic) or may be only partially crystallized. For example, it is possible to use Li—P—S-based glass containing Li, P, and S or Li—P—S-based glass ceramic containing Li, P, and S.

The sulfide-based inorganic solid electrolytes can be manufactured by a reaction of at least two raw materials of, for example, lithium sulfide (Li₂S), phosphorus sulfide (for example, diphosphorus pentasulfide (P₂S₅)), a phosphorus single body, a sulfur single body, sodium sulfide, hydrogen sulfide, lithium halides (for example, LiI, LiBr, and LiCl), or sulfides of an element represented by M (for example, SiS₂, SnS, and GeS₂).

The ratio between Li₂S and P₂S₅ in Li—P—S-based glass and Li—P—S-based glass ceramic is preferably 60:40 to 90:10 and more preferably 68:32 to 78:22 in terms of the molar ratio between Li₂S:P₂S₅. In a case where the ratio between Li₂S and P₂S₅ is set in the above-described range, it is possible to increase the lithium ion conductivity. Specifically, the lithium ion conductivity can be preferably set to 1×10⁻⁴ S/cm or more and more preferably set to 1×10⁻³ S/cm or more. The upper limit is not particularly limited but realistically 1×10⁻¹ S/cm or less.

As specific examples of the sulfide-based inorganic solid electrolytes, combination examples of raw materials will be described below. Examples thereof include Li₂S—P₂S₅, Li₂S—P₂S₅—LiCl, Li₂S—P₂S₅—H₂S, Li₂S—P₂S₅—H₂S—LiCl, Li₂S—LiI—P₂S₅, Li₂S—LiI—Li₂O—P₂S₅, Li₂S—LiBr—P₂S₅, Li₂S—Li₂O—P₂S₅, Li₂S—Li₃PO₄—P₂S₅, Li₂S—P₂O₅—P₂O₅, Li₂S—P₂S₅—SiS₂, Li₂S—P₂S₅—SiS₂—LiCl, Li₂S—P₂S₅—SnS, Li₂S—P₂S₅—Al₂S₃, Li₂S—GeS₂, Li₂S—GeS₂—ZnS, Li₂S—Ga₂S₃, Li₂S—GeS₂—Ga₂S₃, Li₂S—GeS₂—P₂S₅, Li₂S—GeS₂—Sb₂S₅, Li₂S—GeS₂—Al₂S₃, Li₂S—SiS₂, Li₂S—Al₂S₃, Li₂S—SiS₂—Al₂S₃, Li₂S—SiS₂—P₂S₅, Li₂S—SiS₂—P₂S₅—LiI, Li₂S—SiS₂—LiI, Li₂S—SiS₂—Li₄SiO₄, Li₂S—SiS₂—Li₃PO₄, Li₁₀GeP₂S₁₂, and the like. Mixing ratios of the individual raw materials do not matter. Examples of a method for synthesizing sulfide-based inorganic solid electrolyte materials using the above-described raw material compositions include an amorphorization method. Examples of the amorphorization methods include a mechanical milling method, a solution method, and a melting quenching method. This is because treatments at a normal temperature become possible, and it is possible to simplify manufacturing steps.

(ii) Oxide-Based Inorganic Solid Electrolytes

Oxide-based inorganic solid electrolytes are preferably compounds which contain oxygen atoms (O), have an ion conductivity of a metal belonging to Group I or II of the periodic table, and have electron-insulating properties.

Specific examples of the compounds include LiₓₐLa_{ya}TiO₃ [xa=0.3 to 0.7 and ya=0.3 to 0.7] (LLT), Li_{xb}La_{yb}Zr_{zb}M^{bb}_{mb}O_{nb} (M^{bb} is at least one element of Al, Mg, Ca, Sr, V, Nb, Ta, Ti, Ge, In or Sn, xb satisfies 5≤xb≤10, yb satisfies 1≤yb≤4, zb satisfies 1≤zb≤4, mb satisfies 0≤mb≤2, and nb satisfies 5≤nb≤20.), Li_{xc}B_{yc}M^{cc}_{zc}O_{nc} (M^{cc} is at least one element of C, S, Al, Si, Ga, Ge, In, or Sn, xc satisfies 0≤xc≤5, yc satisfies 0≤yc≤1, zc satisfies 0≤zc≤1, and nc satisfies 0≤nc≤6), Li_{xd}(Al, Ga)_{yd}(Ti, Ge)_{zd}Si_{ad}P_{md}O_{nd} (1≤xd≤3, 0≤yd≤1, 0≤zd≤2, 0≤ad≤1, 1≤md≤7, 3≤nd≤13), Li₍₃₋₂ₓₑ₎M^{ee}ₓₑD^{ee}O (xe represents a number of 0 or more and 0.1 or less, and M^{ee} represents a divalent metal atom. D^{ee} represents a halogen atom or a combination of two or more halogen atoms.), Li_{xf}Si_{yf}O_{zf} (1≤xf≤5, 0<yf≤3, 1≤zf≤10), Li_{xg}S_{yg}O_{zg} (1≤xg≤3, 0<yg≤2, 1≤zg≤10), Li₃BO₃—Li₂SO₄, Li₂O—B₂O₃—P₂O₅, Li₂O—SiO₂, Li₆BaLa₂Ta₂O₁₂, Li₃PO_{(4-3/2w)}N_{w} (w satisfies w<1), Li_{3.5}Zn_{0.25}GeO₄ having a lithium super-ionic conductor (LISICON)-type crystal structure, La_{0.55}Li_{0.35}TiO₃ having a perovskite-type crystal structure, LiTi₂P₃O₁₂ having a natrium super-ionic conductor (NASICON)-type crystal structure, Li_{1+xh+yh}(Al, Ga)ₓₕ(Ti, Ge)₂₋ₓₕSi_{yh}P_{3-yh}O₁₂ (0≤xh≤1, 0≤yh≤1), Li₇La₃Zr₂O₁₂ (LLZ) having a garnet-type crystal structure, and the like. In addition, phosphorus compounds containing Li, P, and O are also desirable. Examples thereof include lithium phosphate (Li₃PO₄), LiPON in which some of oxygen atoms in lithium phosphate are substituted with nitrogen, LiPOD¹ (D¹ is at least one element selected from Ti, V, Cr, Mn, Fe, Co, Ni, Cu, Zr, Nb, Mo, Ru, Ag, Ta, W, Pt, Au, or the like), and the like. It is also possible to preferably use LiA¹ON (A¹ represents at least one element selected from Si, B, Ge, Al, C, Ga, or the like) and the like.

The volume-average particle diameter of the inorganic solid electrolyte is not particularly limited but is preferably 0.01 μm or more and more preferably 0.1 μm or more. The upper limit is preferably 100 μm or less and more preferably 50 μm or less. Meanwhile, the average particle diameter of the inorganic solid electrolyte particles is measured in the following order. One percent by mass of a dispersion liquid is prepared by the use of the inorganic solid electrolyte particles and water (heptane in a case where the inorganic solid electrolyte is unstable in water) in a 20 ml sample bottle. The diluted dispersion specimen is irradiated with 1 kHz ultrasonic waves for 10 minutes and is then immediately used for testing. Data capturing is carried out 50 times using this dispersion liquid specimen, a laser diffraction/scattering-type particle size distribution measurement instrument LA-920 (trade name, manufactured by Horiba Ltd.), and a silica cell for measurement at a temperature of 25° C., thereby obtaining the volume-average particle diameter. Regarding other detailed conditions and the like, the description of JIS Z8828:2013 “Particle size analysis—Dynamic light scattering method” is referred to as necessary. Five specimens are produced and measured per level, and the average values thereof are employed.

In a case in where a decrease in the interface resistance and the maintenance of the decreased interface resistance in the case of being used in the all-solid state secondary battery are taken into account, the content of the inorganic solid electrolyte in the solid component of the solid electrolyte composition is preferably 5% by mass or more, more preferably 10% by mass or more, and particularly preferably 20% by mass or more with respect to 100% by mass of the solid components. From the same viewpoint, the upper limit is preferably 99.9% by mass or less, more preferably 99.5% by mass or less, and particularly preferably 99% by mass or less.

However, in a case where the solid electrolyte composition contains an active material described below, regarding the content of the inorganic solid electrolyte in the solid electrolyte composition, the total content of the active material and the inorganic solid electrolyte is preferably in the above-described range.

The inorganic solid electrolyte may be used singly, or two or more inorganic solid electrolytes may be used in combination.

Meanwhile, the solid content (solid component) in the present specification refers to a component that does not volatilize or evaporate and thus disappear in the case of being subjected to a drying treatment in a nitrogen atmosphere at 170° C. for six hours. Typically, the solid content refers to a component other than a dispersion medium described below.

(Binder (B))

The solid electrolyte composition of the embodiment of the present invention contains a binder (B).

The polymer constituting the binder (B) used in the present invention (hereinafter, also referred to as “binder polymer”) is an organic polymer and has a partial structure including an acyclic siloxane structure represented by General Formula (I) and a partial structure represented by General Formula (II).

The form of the binder polymer used in the present invention is not limited and may be any one of a linear polymer, a graft polymer, and a polymer having a three-dimensional crosslinked structure. Further, the form of the binder polymer may be a random copolymer or a block copolymer.

In a case where the binder polymer used in the present invention is a graft polymer, the binder polymer may have a partial structure including an acyclic siloxane structure represented by General Formula (I) and a partial structure represented by General Formula (II) in any of the main chain and the side chain.

In a case where the binder polymer used in the present invention has a three-dimensional crosslinked structure, the binder polymer may have at least one of a partial structure including an acyclic siloxane structure represented by General Formula (I) or a partial structure represented by General Formula (II) as a crosslinking component.

In addition, the binder polymer may have a component other than the partial structure including the acyclic siloxane structure represented by General Formula (I) and the partial structure represented by General Formula (II).

In the description of the present invention, the “main chain” refers to a linear molecular chain among all of molecular chains in the binder polymer, in which all of molecular chains (long molecular chains and/or short molecular chains) other than the side chain can be regarded as pendants with respect to the main chain. Typically, the longest chain among the molecular chains constituting the polymer is the main chain. However, the functional group or organic group at the polymer terminal is not included in the main chain and is separately defined as a terminal functional group or an organic group.

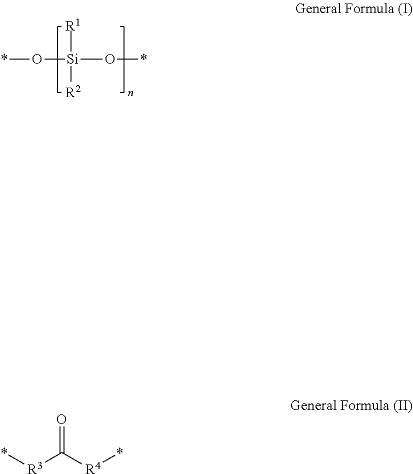

In General Formula (I), R¹ and R² each independently represent a hydrogen atom or a substituent. n represents an integer of 1 or greater. * indicates a bonding portion in the binder polymer. In a case where n is 2 or more, the repeating unit may be one single type or may be formed of two or more types of repeating units.

In General Formula (II), R³ and R⁴ each independently represent a divalent linking group.

Partial Structure Including Acyclic Siloxane Structure

“Siloxane” is a compound having a skeleton of a bond between a silicon atom and an oxygen atom (siloxane bond, Si—O), and particularly a compound having a partial skeleton having a Si—O—Si bond is referred to as a siloxane compound. Since siloxane hardly inhibits the conduction of lithium ions, the binder (B) formed of a polymer having a siloxane structure exhibits high ion conductivity.

The “acyclic siloxane structure” refers to a linear siloxane structure having a repeating siloxane bond as the main chain and having no ring composed of a silicon atom and an oxygen atom. The acyclic siloxane structure may have a branched structure as long as the acyclic siloxane does not include the above-described ring. In a case where a cyclic siloxane structure is introduced into the binder polymer, the rigidity of the binder polymer increases, and thus the binding property with an inorganic solid electrolyte decreases.

“Including an acyclic siloxane structure” in the “partial structure including an acyclic siloxane structure” means that both (1) a form composed of an acyclic siloxane structure and (2) a form having a structure other than the acyclic siloxane structure, which is derived from a monomer forming a partial structure including an cyclic siloxane structure, and having an acyclic siloxane structure are included. Examples of the structure other than the acyclic siloxane structure include a structure having a partial structure represented by General Formula (II).

The weight-average molecular weight of the partial structure including the acyclic siloxane is preferably 10,000 or less, more preferably 7,000 or less, and still more preferably 3,000 or less, from the viewpoint of reactivity during the synthesis of the binder polymer. The lower limit is not particularly limited but is practically 1,000 or more. The weight-average molecular weight can be calculated from the monomer as a raw material.

The weight-average molecular weight of the binder (B) is preferably 10,000 to 500,000, more preferably 15,000 to 300,000, and particularly preferably 20,000 to 150,000.

n is preferably an integer of 3 to 180, more preferably an integer of 5 to 150, and particularly preferably an integer of 10 to 100.

In General Formula (I), R¹ and R² each independently represent a hydrogen atom or a substituent. n represents an integer of 1 or greater. As a substituent, a substituent belonging to [Substituent Group I] and a group represented by General formula (III) or (IV) can be mentioned.

[Substituent Group I]

Alkyl group, alkoxy group, aryl group, aryloxy group, heteroaryl group, heteroaryloxy group

The number of carbon atoms in the alkyl group is preferably 10 or less, more preferably 5 or less, and still more preferably 1 or 2. The alkyl group may be linear or cyclic, and examples thereof include methyl, ethyl, i-propyl, t-butyl, and cyclohexyl.

An alkyl group in the alkoxy group has the same meaning as the alkyl group described above, and a preferred range thereof is also identical thereto.

The number of carbon atoms constituting the ring of the aryl group is preferably 20 or less, more preferably 15 or less, and still more preferably 8 or less. The lower limit is 6, preferably 8 or more, more preferably 12 or more. Specific examples of aryl groups include phenyl, naphthyl, and anthracenyl.

An aryl group in the aryloxy group has the same meaning as the aryl group described above, and a preferred range thereof is also identical thereto.

The number of carbon atoms constituting a ring of the heteroaryl group is preferably 20 or less, more preferably 15 or less, and still more preferably 8 or less. The lower limit is 0, preferably 2 or more, and more preferably 4 or more. The number of hetero atoms (for example, a nitrogen atom, a sulfur atom, an oxygen atom) constituting a ring of the heteroaryl group is preferably 1 to 5. The ring of the heteroaryl group is preferably a 4- to 8-membered ring, and specific examples of the ring include imidazole, oxazole, thiazole, furan, and pyridine.

An aryloxy group in the heteroaryloxy group has the same meaning as the aryloxy group described above, and a preferred range thereof is also identical thereto.

It is preferable that any one of R¹ or R² in General Formula (I) is a group represented by General Formula (III) or (IV).

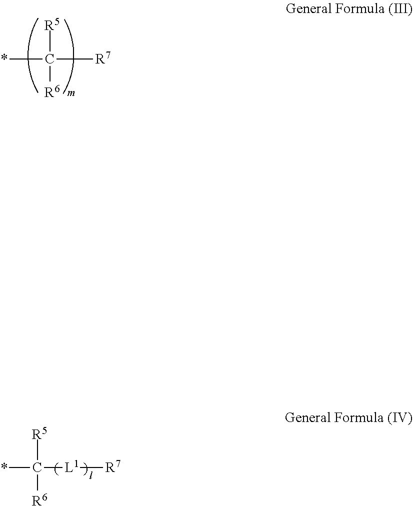

In the formulae, R⁵, R⁶, and R⁷ each independently represent a hydrogen atom or a substituent. m and I each independently represent an integer of 1 to 100. L¹ represents a divalent linking group. * represents a bonding portion in the polymer constituting the binder (B). More specifically, * represents a bonding portion with a silicon atom in Formula (I).

It is preferable that at least one of R⁵, R⁶, or R⁷ includes a group selected from [Substituent Group II]. Further, two or more functional groups selected from the Functional group Group II may be combined.

Further, R⁵ and R⁶ are preferably an alkyl group having 5 or fewer carbon atoms.

[Substituent Group II]

Alkyl group, alkoxy group, aryl group, aryloxy group, heteroaryl group, heteroaryloxy group, amino group, cyano group, hydroxy group, carboxy group, epoxy group

The number of carbon atoms in the alkyl group is preferably 20 or less, more preferably 10 or less, and still more preferably 5 or less. The alkyl group may be linear or cyclic, and examples thereof include methyl, ethyl, i-propyl, t-butyl, and cyclohexyl.

An alkyl group in the alkoxy group has the same meaning as the alkyl group described above, and a preferred range thereof is also identical thereto.

The aryl group, the aryloxy group, the heteroaryl group, and the heteroaryloxy group respectively have the same meanings as the aryl group, the aryloxy group, the heteroaryl group, and the heteroaryloxy group described in Substituent Group I, and the preferred ranges are also identical thereto.

Examples of the divalent linking groups represented by L¹ include oxyalkylene groups such as a divalent group derived from ethylene glycol, a divalent group derived from propylene glycol, and a divalent group derived from tetramethylene glycol, a divalent group derived from a compound containing an ester bond, and a divalent group derived from a compound having a carbonate structure.

The values of m and l are not particularly limited but are preferably 50 or less, and more preferably 20 or less, from the viewpoint of suppressing a decrease in binding property due to high molecular weight.

The partial structure including the acyclic siloxane structure represented by General Formula (I) is preferably formed by incorporating a monomer represented by General Formula (1).

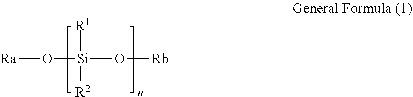

In General Formula (1), R¹, R², and n are the same as R¹, R², and n in General Formula (I), and preferred ranges are also identical thereto. Ra and Rb represent a hydrogen atom, a group having a nucleophilic reactive hetero atom, a group having an ethylenically unsaturated group, or a non-reactive substituent. Here, at least one of Ra or Rb is a group having a nucleophilic reactive hetero atom or a group having an ethylenically unsaturated group.

Examples of the nucleophilic reactive hetero atoms in the group having a nucleophilic reactive hetero atom include a hydroxy group, an amino group, and a sulfanyl group (—SH).

The ethylenically unsaturated group in the group having an ethylenically unsaturated group is preferably a vinyl group which may have a substituent, and more preferably a vinyl group, an acryloyl group, a methacryloyl group, an acryloyloxy group, a methacryloyloxy group, an acryloylamino group, and a methacryloylamino group.

The group having an ethylenically unsaturated group is a group in which the above-mentioned ethylenically unsaturated group is bonded to a single bond or a divalent linking group, examples of the divalent linking group include an alkylene group and an arylene group, and an alkylene group is preferable.

The group having an ethylenically unsaturated group is particularly preferably a group represented by General Formula (a).

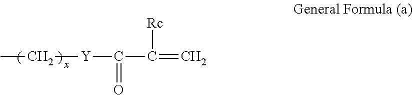

In General Formula (a), Rc represents a hydrogen atom or an alkyl group. Y represents —O— or —NR—. x is an integer of 1 to 10. Here, R represents a hydrogen atom or a substituent.

The substituent in R is preferably an aliphatic group, an aryl group or a heterocyclic group.

In addition, as the aliphatic group, an alkyl group and a cycloalkyl group are preferable, and an alkyl group is more preferable.

An alkyl group represented by Rc has the same meaning as the alkyl group in Substituent Group II, and the preferred range is also identical thereto.

An alkyl group represented by R has the same meaning as the alkyl group in Substituent Group II, and the preferred range is also identical thereto.

A cycloalkyl group represented by R preferably has 3 to 10 carbon atoms and more preferably 5 to 8 carbon atoms.

An aryl group represented by R has the same meaning as the aryl group in Substituent Group I, and the preferred range is also identical thereto.

A heterocyclic group represented by R has the same meaning as the heteroaryl group in Substituent Group I, and the preferred range is also identical thereto.

Specific examples of the monomer forming the partial structure including the acyclic siloxane are shown below, but the present invention is not limited to the following specific examples. In the following specific examples, p represents an integer of 1 to 50. q represents an integer of 5 to 50. r represents an integer of 1 to 20.

Here, Me is a methyl group (—CH₃), Et is an ethyl group (—C₂H₅), and Ph is a phenyl group (—C₆H₅).

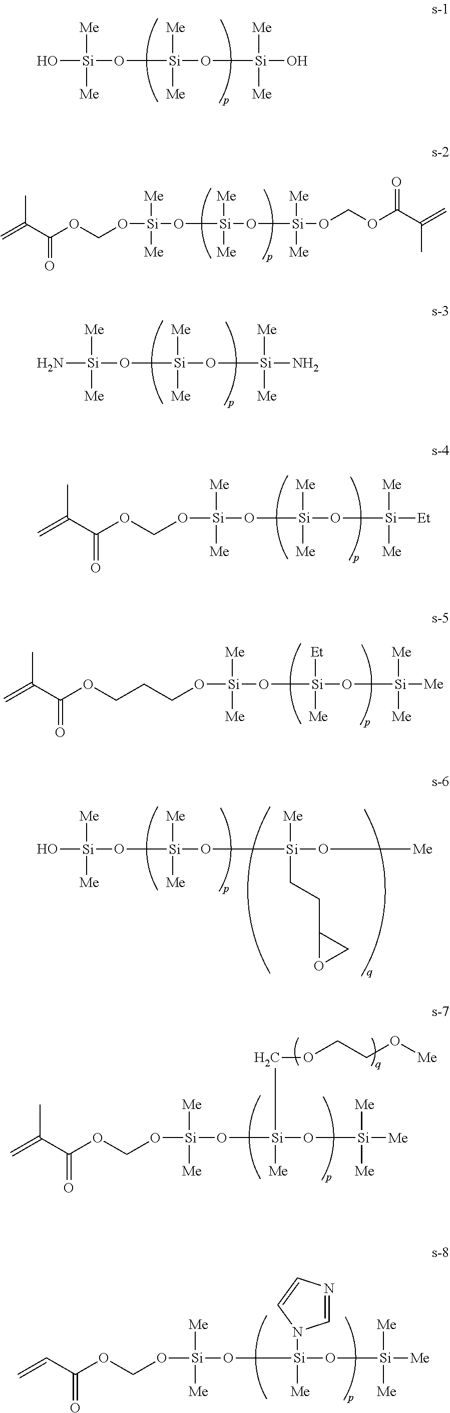

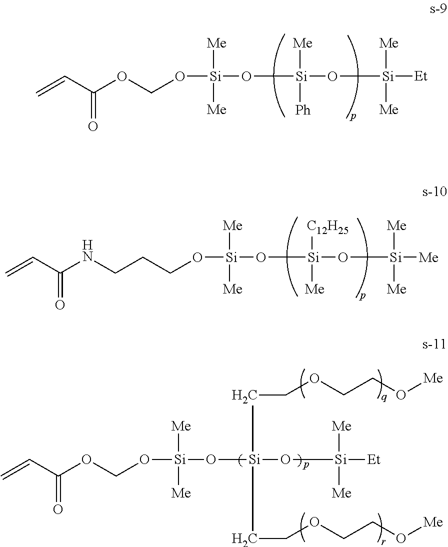

The binder polymer includes a partial structure represented by General Formula (II). In a case where a carbonyl group of the binder polymer interacts with the solvent (D) and a functional group on the surface of the inorganic solid electrolyte, the dispersibility of the solid electrolyte composition is further improved.

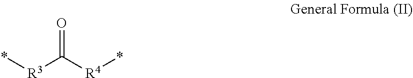

In the formula, R³ and R⁴ each independently represent a divalent linking group. * indicates a bonding portion in the binder polymer.

The divalent linking group is not particularly limited, but at least one of R³ or R⁴ preferably represents a divalent hetero atom or a divalent linking group containing a hetero atom, and at least one of R³ or R⁴ more preferably represents —O—, —NR—, or —S— or a divalent linking group containing —O—, —NR—, or —S—. R represents a hydrogen atom or a substituent. The binder polymer may have a combination of two or more of the partial structures represented by General Formula (II). R³ and R⁴ may include a repeating structure.

Here, a substituent in R has the same meaning as R in General Formula (a), and the preferred range is also identical thereto.

The binder polymer preferably includes a partial structure represented by General Formula (V) for the purpose of improving ion conductivity.

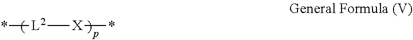

In the formula, L² is a divalent linking group, and p represents an integer of 3 to 300. * indicates a bonding portion in the binder polymer. X represents —O—, —NR— (R has the same meaning as R in General Formula (a), and the preferred range is identical thereto), or —S—, and is preferably —O—. The divalent linking group represented by L² preferably has an oxygen atom and may have a repeating structure. However, a “—O—O—” bond is not included.

L² in General Formula (V) is preferably a structure represented by General Formula (VI) for improving affinity with a lithium ion and lowering the glass transition temperature of the polymer constituting the binder (B).

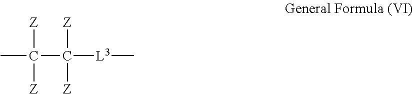

In the formula, Z's each independently represent a hydrogen atom or a substituent. L³ represents a single bond or a divalent linking group.

Examples of the substituent represented by Z include a substituent represented by R¹, an alkyl group represented by R¹ is preferable, and a preferred range of the alkyl group is also identical thereto.

As the divalent linking group represented by L³, an alkylene group such as methylene (—CH₂—) and ethylene (—CH₂CH₂—), a carbonyl group (—C(═O)—), —O—, and a combination thereof are preferable.

Examples of the structure represented by General Formula (V) include oxyalkylene groups such as a divalent structure in which hydrogen atoms are from both ends of the main chain of polyethylene glycol, a divalent structure in which hydrogen atoms are removed from both ends of the main chain of polypropylene glycol, and a divalent structure in which hydrogen atoms are removed from both ends of the main chain of polytetramethylene glycol, a divalent structure in which hydrogen atoms are removed from both ends of polyester main chain, and a divalent structure in which hydrogen atoms are removed from both ends of polycarbonate main chain. p is preferably an integer of 50 or lower, and more preferably an integer of 20 or lower, from the viewpoint of suppressing a decrease in binding property due to high molecular weight.

The partial structure represented by General Formula (II) is preferably incorporated as a monomer represented by General Formula (2).

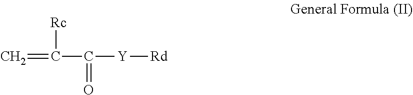

In General Formula (2), Rc and Y respectively have the same meanings as Rc and Y in General Formula (a), and the preferred range is also identical thereto. Rd represents a hydrogen atom or a substituent.

The substituent indicates an aliphatic group, an aryl group, or a heterocyclic group. The substituent in Rd may have an ethylenically unsaturated group and may have a hydroxy group, an amino group, a carboxy group, a phosphate group, a halogen atom such as a fluorine atom, a cyano group, or an isocyanate group.

As the aliphatic group represented by Rd, an alkyl group and a cycloalkyl group are preferable.

The number of carbon atoms in the alkyl group is preferably 3 to 50, more preferably 2 to 30, and still more preferably 1 to 10. The alkyl group may be linear or cyclic, and may have —O—, —C(═O)—, and/or a combination thereof in the chain.

A cycloalkyl group represented by Rd has the same meaning as the cycloalkyl group represented by R, and the preferred range is also identical thereto.

An aryl group and a heterocyclic group represented by Rd respectively have the same meanings as the aryl group and heterocyclic group represented by R, and the preferred range is also identical thereto.

In a case where the polymer chain has a urethane bond or a ureide bond, the partial structure represented by General Formula (II) is obtained by a condensation reaction between a diisocyanate compound and a diol compound, or a diisocyanate compound and an amino compound.

In addition, in a case where the polymer chain has an ester bond, the partial structure represented by General Formula (II) is obtained by condensation reaction between a dicarboxylic acid such as a dicarboxylic acid compound, an acid anhydride thereof, a dicarboxylic acid diester, a dicarboxylic acid dihalide, and a derivative thereof, and a diol compound.

In the case where at least one of Ra or Rb in the monomer represented by General Formula (1) is a group having a nucleophilic reactive hetero atom, the partial structure can also be obtained by reaction with a diisocyanate compound, or dicarboxylic acid or a derivative of the dicarboxylic acid.

The binder polymer preferably has a hydroxy group, a cyano group, an amino group, and/or a carboxy group from the viewpoint of improving the adsorption to the active material and/or the inorganic solid electrolyte. The binder polymer may have one of these functional groups singly or may have two or more of these functional groups in combination.

Examples of the monomer used for polymerization of the binder in the present invention are shown below, but the present invention is not limited thereto. n represents an integer of 1 to 80.

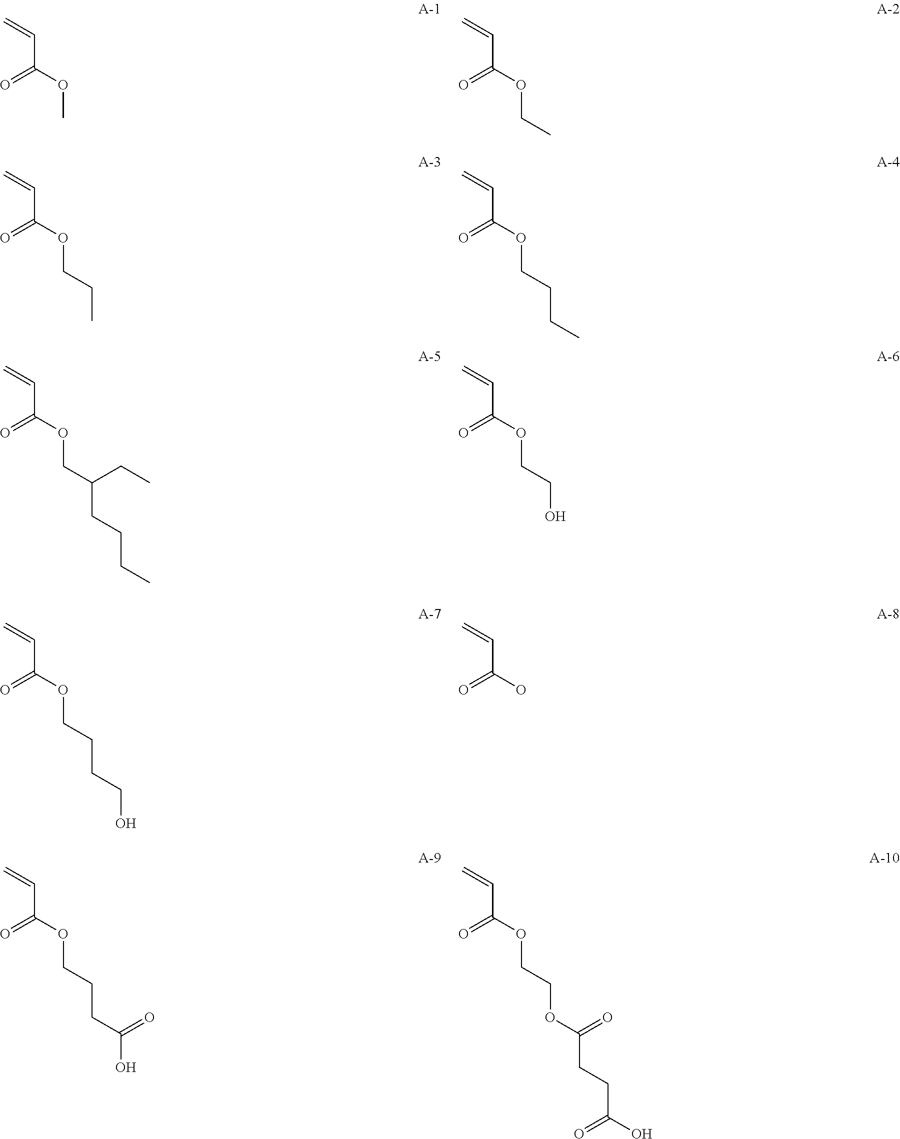

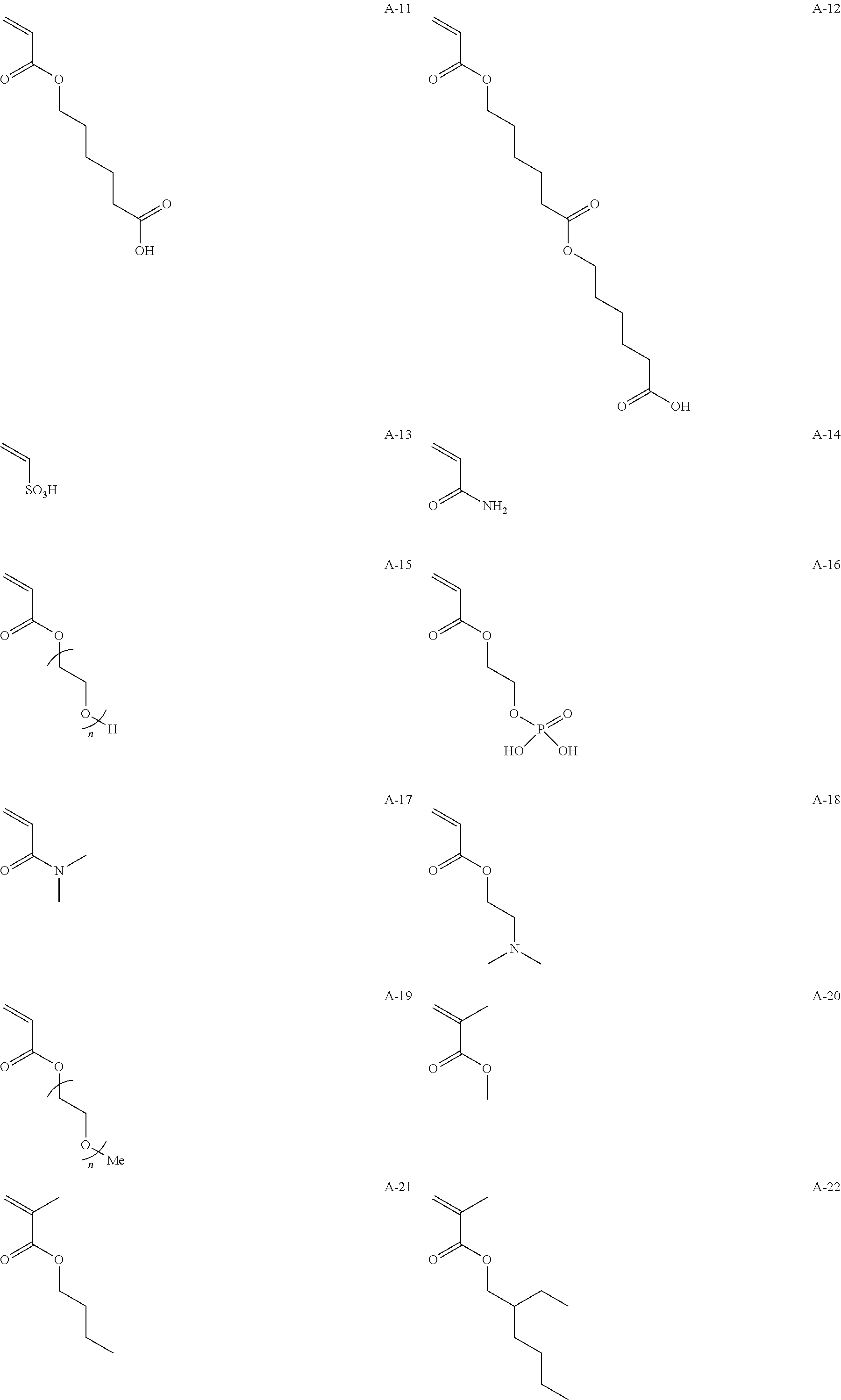

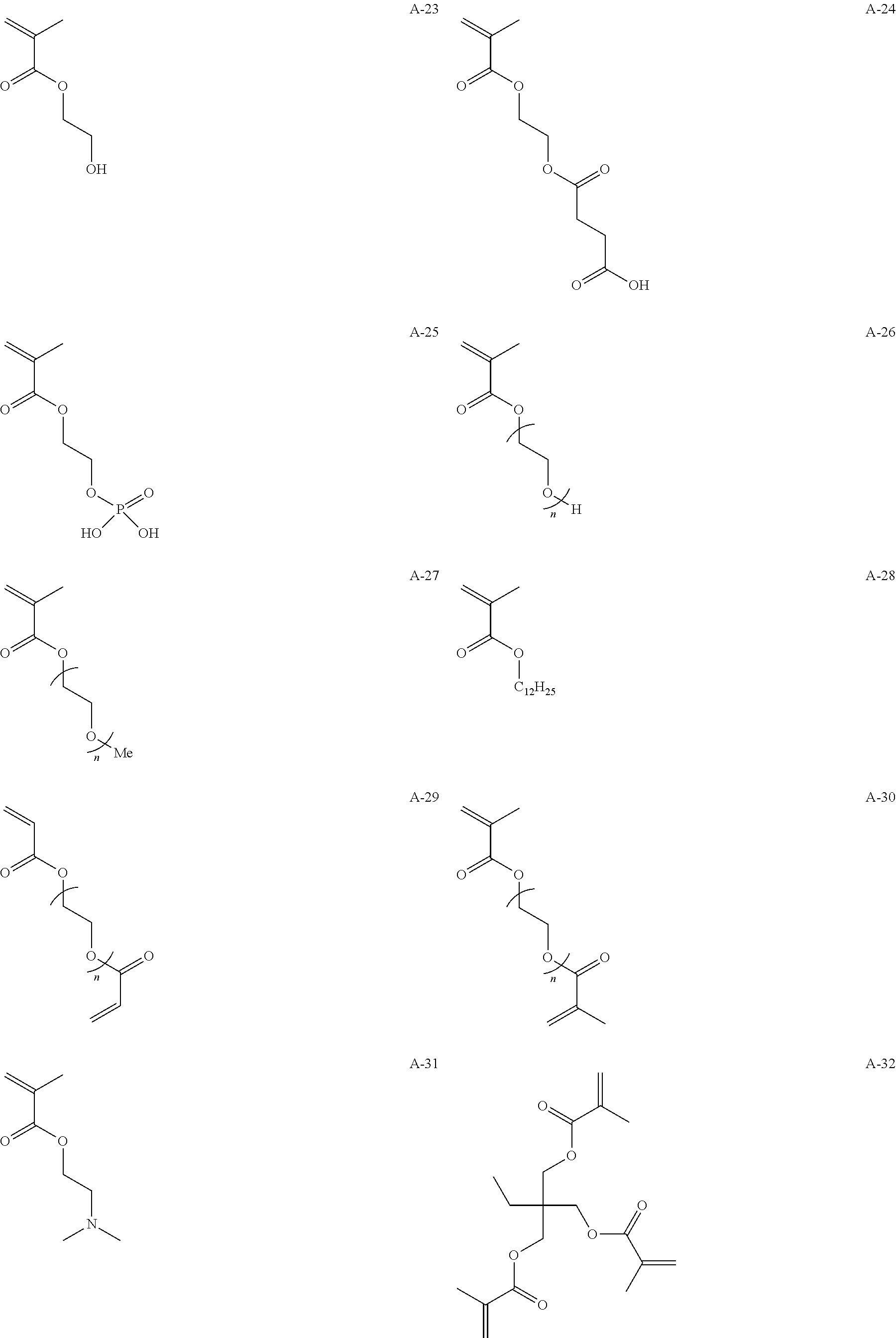

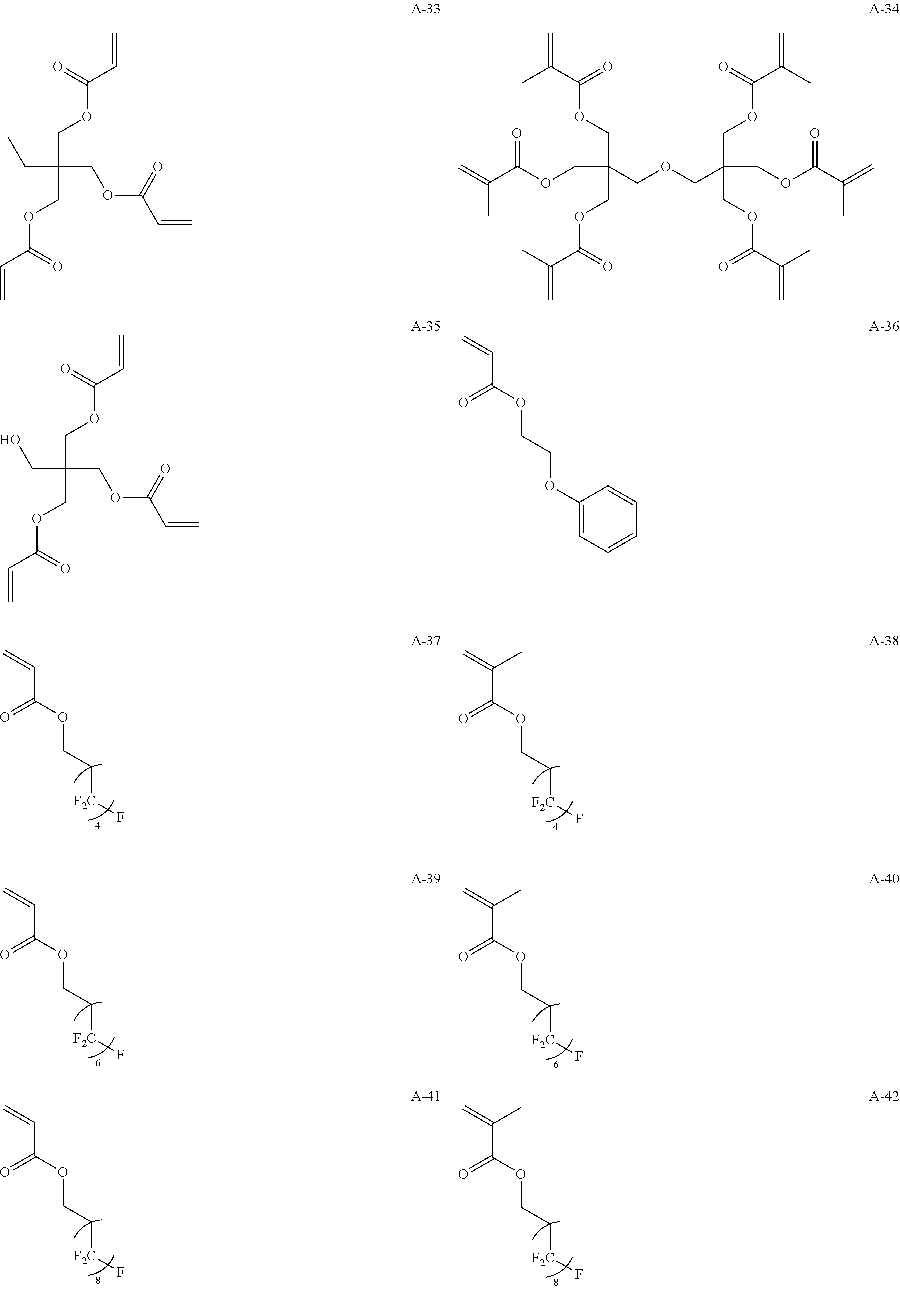

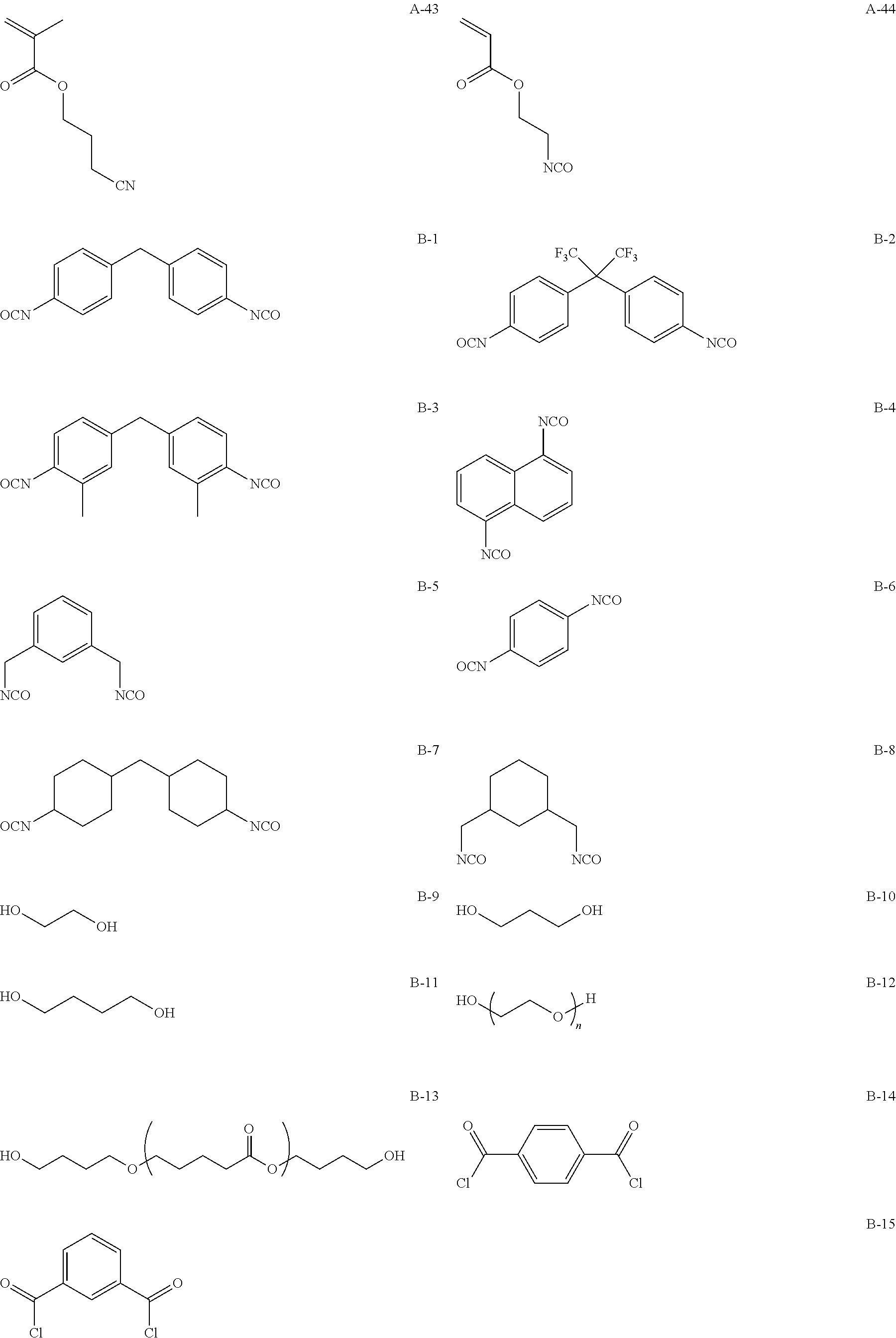

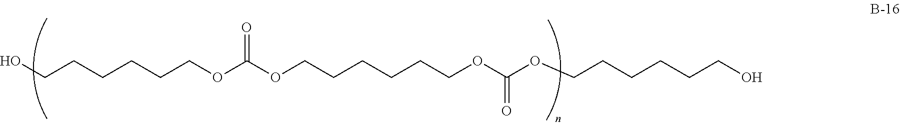

Specific examples of the structure other than the partial structure including the acyclic polysiloxane structure in the binder polymer are shown below. In the present invention, the binder structure is not limited to the following specific examples. The number given to the repeating unit in the following specific examples indicates the % by mass of each repeating unit, and the sum with the partial structure including the acyclic polysiloxane structure is 100% by mass.

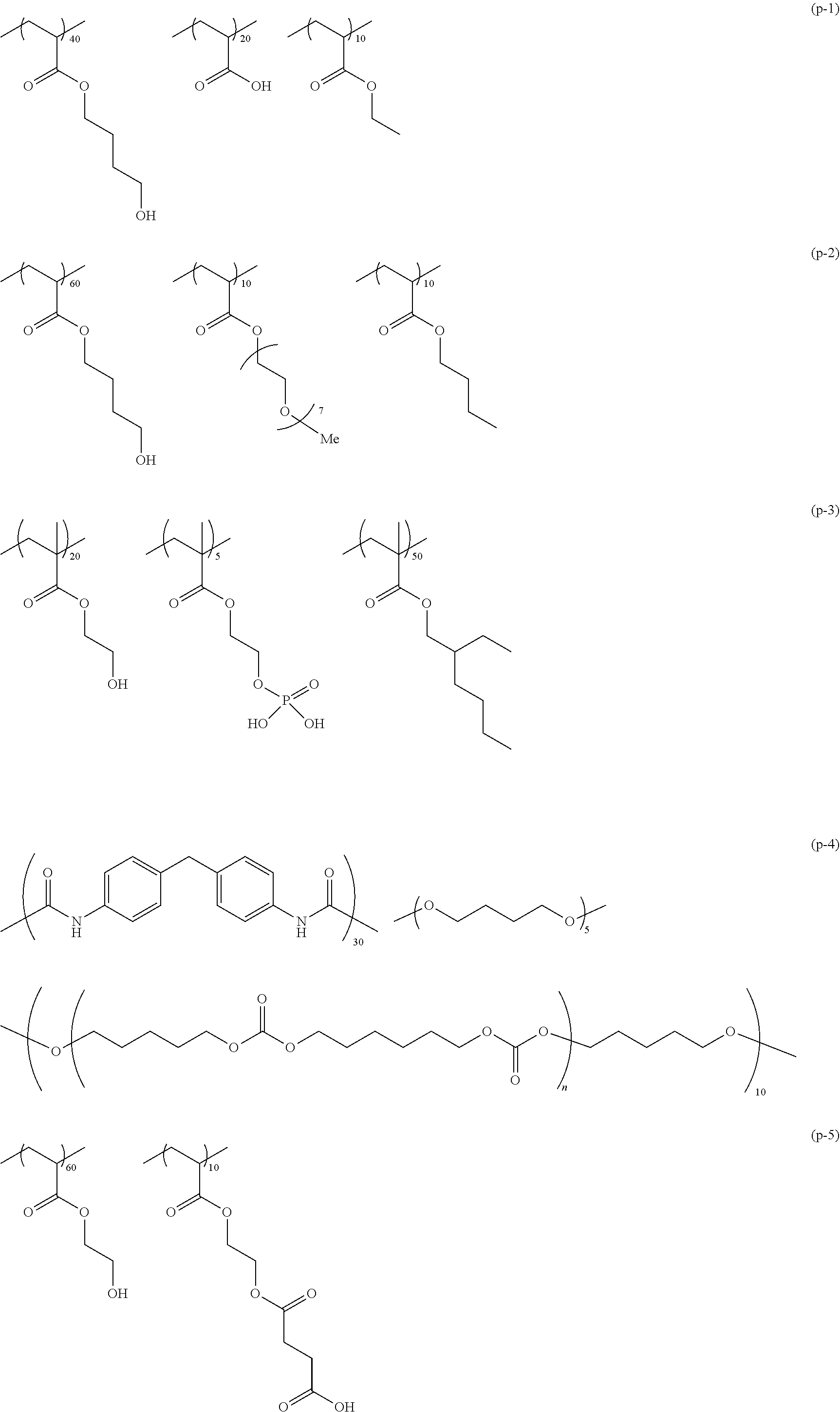

The binder used in the present invention can be synthesized with reference to, for example, the methods described in JP2015-088486A and JP6110823B.

The shape of the binder polymer that is used in the present invention is not particularly limited and may be a particle shape or an irregular shape in the solid electrolyte composition, a solid electrolyte-containing sheet, or an all-solid state secondary battery.

In the present invention, the binder polymer is preferably a particle that is insoluble in the dispersion medium from the viewpoint of the dispersion stability of the solid electrolyte composition and the viewpoint of obtaining an all-solid state secondary battery having a high ion conductivity. Here, the expression “the binder polymer is present as particles that are insoluble in the dispersion medium” means that, even in a case where the polymer (B) is added to the dispersion medium (25° C.) and left to stand for 24 hours, the average particle diameter does not decrease by 10% or more. The average particle diameter preferably does not decrease by 5% or more and more preferably does not decrease by 3% or more.

In addition, the binder polymer in the solid electrolyte composition is preferably a particle shape in order to suppress a decrease in the ion conductivity between the particles of the inorganic solid electrolyte or the like, and the average particle diameter is preferably 10 nm to 1,000 nm and more preferably 100 nm to 500 nm.

The average particle diameter of the particles of the binder (B) that is used in the present invention can be measured, unless particularly otherwise described, under measurement conditions described below.

The binder (B) is diluted in a 20 ml sample bottle using a random solvent (the dispersion medium that is used for the preparation of the solid electrolyte composition, for example, octane), thereby preparing 1% by mass of a dispersion liquid. The diluted dispersion specimen is irradiated with 1 kHz ultrasonic waves for 10 minutes and is then immediately used for testing. Data capturing is carried out 50 times using this dispersion liquid specimen, a laser diffraction/scattering-type particle size distribution measurement instrument LA-920 (trade name, manufactured by Horiba Ltd.), and a silica cell for measurement at a temperature of 25° C., and the obtained volume-average particle diameter is used as the average particle diameter. Regarding other detailed conditions and the like, the description of JIS Z8828:2013 “Particle size analysis—Dynamic light scattering method” is referred to as necessary. Five specimens are produced and measured per level, and the average values thereof are employed.

Meanwhile, the average particle diameter can be measured from the produced all-solid state secondary battery by, for example, disassembling the battery, peeling the electrodes off, then, measuring the average particle diameters of the electrode materials according to the above-described method for measuring the average particle diameter of the binder (B), and excluding the measurement value of the average particle diameter of particles other than the binder (B) which has been measured in advance.

In consideration of the good reduction property of interface resistance and the maintainability thereof when used in an all-solid state secondary battery, a content of the binder (B) used in the present invention in the solid electrolyte composition is preferably 0.01% by mass or more, more preferably, 0.1% by mass or more, and still more preferably 1% by mass or more with respect to 100% by mass of the solid component. From the viewpoint of battery characteristics, the upper limit is preferably 10% by mass or less, more preferably 5% by mass or less, and still more preferably 3% by mass or less.

In the present invention, in order to effectively improve the ion conductivity of the solid electrolyte composition including the inorganic solid electrolyte (A) and the binder (B), a content of the binder (B) with respect to 100 parts by mass of the inorganic solid electrolyte (A) is preferably 0.1 part by mass or more and 20 parts by mass or less, more preferably 0.3 parts by mass or more and 10 parts by mass or less, and particularly preferably 0.5 parts by mass or more and 5 parts by mass or less.

In the present invention, the mass ratio of the total mass (total amount) of the inorganic solid electrolyte and the active material to the mass of the binder (B) [(mass of inorganic solid electrolyte and mass of active material)/mass of binder (B)] is preferably in a range of 1,000 to 1. Further, this ratio is more preferably 500 to 2 and still more preferably 100 to 10.

The solvent used for the polymerization reaction or the condensation reaction of the binder polymer is not particularly limited. It is preferable to use a solvent that does not react with the inorganic solid electrolyte or the active material and that does not decompose them. For example, a hydrocarbon solvent (toluene, heptane, xylene), an ester solvent (ethyl acetate, propylene glycol monomethyl ether acetate), an ether solvent (tetrahydrofuran, dioxane, 1,2-diethoxyethane), a ketone solvent (acetone, methylethyl ketone, cyclohexanone)), a nitrile solvent (acetonitrile, propionitrile, butyronitrile, isobutyronitrile), or a halogen solvent (dichloromethane, chloroform) can be used. From the viewpoints of low reactivity to the inorganic solid electrolyte and the active material and the boiling point, the structure of the reaction solvent preferably contains 4 or more carbon atoms, and more preferably 6 or more carbon atoms. The upper limit is not particularly limited, but the structure of the reaction solvent preferably contains 12 or fewer carbon atoms.

In the present invention, as the binder (B), one of the above binders may be used singly, or two or more may be used in combination.

The polymer constituting the binder (B) used in the present invention preferably has a moisture concentration of 100 ppm (by mass) or less.

In addition, the polymer constituting the binder (B) used in the present invention may be crystallized and dried, or the polymer solution may be used as it is. It is preferable that the amount of the metal catalyst (tin, titanium, and bismuth as urethanization catalyst or polyesterization catalyst) is small. It is preferable to reduce the metal concentration in the copolymer to 100 ppm (by mass) or less by reducing the amount of metal during polymerization or removing the catalyst by crystallization.

(Dispersion Medium (C))

Even in a case where the dispersion medium (C) used in the present invention is added with the inorganic solid electrolyte (A) at 25° C. and allowed to stand for 6 hours, the decrease in the average particle diameter of the inorganic solid electrolyte (A) is 5% or less (preferably 3% or less). The dispersion medium (C) is preferably a compound having a LogP value of 16 or more and 18.5 or less (preferably 16 or more and 18 or less).

The LogP value is a value calculated by ChemBioDraw (trade name) Version: 12.9.2.1076 manufactured by PerkinElmer.

Specific examples of the dispersion medium include dispersion media of the compound described below.

Examples of the ketone compound dispersion medium include 3,3,5-trimethylcyclohexanone and dibutyl ketone.

Examples of the ester compound dispersion medium include hexyl acetate, butyl propionate, pentyl butyrate, methyl valerate, butyl valerate, and butyl caproate.

Examples of the aromatic compound dispersion medium include benzene, toluene, ethylbenzene, and xylene.

Examples of the aliphatic compound dispersion medium include hexane, heptane, cyclohexane, methylcyclohexane, ethylcyclohexane, octane, nonane, decane, pentane, cyclopentane, decalin, and cyclooctane.

The dispersion medium preferably has a boiling point of 50° C. or higher, and more preferably 70° C. or higher at normal pressure (1 atm). The upper limit is preferably 250° C. or lower, and more preferably 220° C. or lower.

The dispersion medium may be used singly, or two or more types thereof may be used in combination.

From the viewpoint of improving the affinity with the siloxane structure, an ester compound dispersion medium and a hydrocarbon dispersion medium are preferable, and a hydrocarbon dispersion medium (an aromatic compound dispersion medium and an aliphatic compound dispersion medium) is more preferable.

Among hydrocarbon dispersion media, toluene or xylene is preferable as the aromatic compound dispersion medium, and heptane, octane, cyclohexane, or cyclooctane is preferable as the aliphatic compound dispersion medium.

The proportion of the total content of the dispersion medium (C) and the solvent (D) in the solid electrolyte composition of the embodiment of the present invention is not particularly limited, but is preferably 20% to 80% by mass, more preferably 30% to 70% by mass, and particularly preferably 40% to 60% by mass.

(Solvent (D))

As the solvent (D) used in the present invention, a compound having any one of a fluorine atom, an oxygen atom, a nitrogen atom, or a chlorine atom in a chemical structure is used. In a case where the solvent (D) is added with the inorganic solid electrolyte (A) at 25° C. and allowed to stand for 6 hours, the decrease in the average particle diameter of the inorganic solid electrolyte (A) is 5% or more (preferably 8% or more). The solvent (D) is preferably a compound having a LogP value of more than 18.5 and 23 or less (preferably 19 or more and 23 or less).

The fluorine atom, oxygen atom, nitrogen atom, and chlorine atom have high electronegativity and increase the polarization of the charge in the solvent (D) molecule. The polarized solvent interacts with the oxygen atom of the binder and each of the functional groups on the surface of the inorganic solid electrolyte to improve the dispersibility of the solid electrolyte composition in combination with the dispersion medium. Specific examples of the solvent (D) include the solvent described below.

Examples of the solvent having a fluorine atom include hydrofluoroether (Novec, registered trademark, compound name: heptafluoro-1-methoxypropane, manufactured by 3M), Vertrel (registered trademark, compound name: perfluoro-2H, 3H-pentane, Mitsui DuPont Fluorochemical Co., Ltd.), Fluorinert (registered trademark, compound name: fluorocarbon mixture, manufactured by 3M), decafluoropentane, and tetradecafluorohexane.

Examples of the solvent having an oxygen atom include methyl alcohol, ethyl alcohol, 1-propyl alcohol, 2-butanol, 2-methyl-2-propanol, ethylene glycol, propylene glycol, glycerin, 1,6-hexanediol, 1,3-butanediol, 1,4-butanediol, alkylene glycol alkyl ethers (ethylene glycol monomethyl ether, ethylene glycol monobutyl ether, diethylene glycol, dipropylene glycol, propylene glycol monomethyl ether, diethylene glycol monomethyl ether, triethylene glycol, polyethylene glycol, propylene glycol dimethyl ether, dipropylene glycol monomethyl ether, tripropylene glycol monomethyl ether, diethylene glycol monobutyl ether, diethylene glycol dibutyl ether, and the like), dialkyl ethers (dimethyl ether, diethyl ether, dipropyl ether, dibutyl ether, and the like), tetrahydrofuran, dioxane (including 1,2-, 1,3- and 1,4-isomer), acetone, methyl ethyl ketone, diethyl ketone, dipropyl ketone, diisopropyl ketone, dibutyl ketone, diisobutyl ketone, methyl acetate, ethyl acetate, propyl acetate, butyl acetate, pentyl acetate, methyl propionate, ethyl propionate, propyl propionate, methyl butyrate, ethyl butyrate, propyl butyrate, butyl butyrate, methyl valerate, ethyl valerate, propyl valerate, methyl caproate, ethyl caproate, propyl caproate, isopropyl methanesulfonate, isopropyl ethanesulfonate, ethyl methanesulfonate, 1,3-propane sultone, tetramethylene sulfoxide, tetrahydrothiophene 1,1-dioxide, methyl ethyl sulfone, and ethylisopropyl sulfone.

Examples of the solvent having a nitrogen atom include N,N-dimethylformamide, 1-methyl-2-pyrrolidone, 2-pyrrolidinone, 1,3-dimethyl-2-imidazolidinone, ε-caprolactam, formamide, N-methylformamide, acetamide, N-methylacetamide, N,N-dimethylacetamide, N-methylpropanamide, hexamethylphosphoric triamide, triethylamine, tributylamine, N,N-diisopropylethylamine, 1-methylpiperidine, 2,6-dimethylpiperidine, acetonitrile, propionitrile, and butyronitrile.

Examples of the solvent having a chlorine atom include methylene chloride, chloroform, and 1,2-dichloropropane.

Among these, from the viewpoint of achieving high dispersibility of the solid electrolyte composition by interacting with a polar group of the inorganic solid electrolyte (A) and the binder (B), a solvent having a carbonyl group or a sulfonyl group is preferred.

The solvent may be used singly, or two or more types thereof may be used in combination.

In the solid electrolyte composition of the embodiment of the present invention, the proportion of the content of the solvent (D) in the total content of the dispersion medium (C) and the solvent (D) is not particularly limited, but is preferably 1% to 80% by mass, more preferably 2% to 70% by mass, and particularly preferably 3% to 50% by mass.

<(E) Active Material>

The solid electrolyte composition of the embodiment of the present invention may further contain an active material capable of intercalating and deintercalating ions of a metal element belonging to Group I or II of the periodic table.

As the active material, a positive electrode active material and a negative electrode active material are mentioned, and a transition metal oxide that is the positive electrode active material or a metal oxide that is the negative electrode active material is preferable.

In the present invention, the solid electrolyte composition containing the active material (a positive electrode active material or a negative electrode active material) will be referred to as a composition for an electrode (a composition for a positive electrode or a composition for a negative electrode).

Positive Electrode Active Material

A positive electrode active material that the solid electrolyte composition of the embodiment of the present invention may contain is preferably a positive electrode active material capable of reversibly intercalating and deintercalating lithium ions. The above-described material is not particularly limited as long as the material has the above-described characteristics and may be transition metal oxides, organic substances, elements capable of being complexed with Li such as sulfur, complexes of sulfur and metal, or the like.

Among these, as the positive electrode active material, transition metal oxides are preferably used, and transition metal oxides having a transition metal element M^{a} (one or more elements selected from Co, Ni, Fe, Mn, Cu, and V) are more preferred. In addition, an element M^{b} (a metal other than lithium, an element of Group I (Ia) and an element of Group II (IIa) of the periodic table, or an element such as Al, Ga, In, Ge, Sn, Pb, Sb, Bi, Si, P, and B) may be mixed with this transition metal oxide. The amount of the element mixed is preferably 0 to 30 mol % of the amount (100 mol %) of the transition metal element M^{a}. The positive electrode active material is more preferably synthesized by mixing the element into the transition metal oxide so that the molar ratio of Li/M^{a} reaches 0.3 to 2.2.

Specific examples of the transition metal oxides include transition metal oxides having a bedded salt-type structure (MA), transition metal oxides having a spinel-type structure (MB), lithium-containing transition metal phosphoric acid compounds (MC), lithium-containing transition metal halogenated phosphoric acid compounds (MD), lithium-containing transition metal silicate compounds (ME), and the like.

Specific examples of the transition metal oxides having a bedded salt-type structure (MA) include LiCoO₂ (lithium cobalt oxide [LCO]), LiNi₂O₂ (lithium nickelate), LiNi_{0.85}Co_{0.10}Al_{0.05}O₂ (lithium nickel cobalt aluminum oxide [NCA]), LiNi_{1/3}Co_{1/3}Mn_{1/3}O₂ (lithium nickel manganese cobalt oxide [NMC]), and LiNi_{0.5}Mn_{0.5}O₂ (lithium manganese nickelate).

Specific examples of the transition metal oxides having a spinel-type structure (MB) include LiMn₂O₄ (LMO), LiCoMnO₄, Li₂FeMn₃O₈, Li₂CuMn₃O₈, Li₂CrMn₃O₈, and Li₂NiMn₃O₈.

Examples of the lithium-containing transition metal phosphoric acid compounds (MC) include olivine-type iron phosphate salts such as LiFePO₄ and Li₃Fe₂(PO₄)₃, iron pyrophosphates such as LiFeP₂O₇, and cobalt phosphates such as LiCoPO₄, and monoclinic a NASICON-type vanadium phosphate salt such as Li₃V₂(PO₄)₃ (lithium vanadium phosphate).

Examples of the lithium-containing transition metal halogenated phosphoric acid compounds (MD) include iron fluorophosphates such as Li₂FePO₄F, manganese fluorophosphates such as Li₂MnPO₄F, cobalt fluorophosphates such as Li₂CoPO₄F.

Examples of the lithium-containing transition metal silicate compounds (ME) include Li₂FeSiO₄, Li₂MnSiO₄, Li₂CoSiO₄, and the like.

In the present invention, the transition metal oxide having a bedded salt-type structure (MA) is preferred, and LCO, LMO, NCA, or NMC is more preferred.

The shape of the positive electrode active material is not particularly limited but is preferably a particle shape. The volume-average particle diameter (circle-equivalent average particle diameter) of positive electrode active material particles is not particularly limited. For example, the volume-average particle diameter can be set to 0.1 to 50 μm. In order to provide a predetermined particle diameter to the positive electrode active material, an ordinary crusher or classifier may be used. A positive electrode active material obtained using a firing method may be used after being washed with water, an acidic aqueous solution, an alkaline aqueous solution, or an organic solvent. The volume-average particle diameter (circle-equivalent average particle diameter) of positive electrode active material particles can be measured using a laser diffraction/scattering-type particle size distribution measurement instrument LA-920 (trade name, manufactured by Horiba Ltd.).

The positive electrode active material may be used singly, or two or more types thereof may be used in combination.

In the case of forming a positive electrode active material layer, the mass (mg) of the positive electrode active material per unit area (cm²) in the positive electrode active material layer (weight per unit area) is not particularly limited. The weight per unit area can be appropriately determined depending on a set battery capacity.

The content of the positive electrode active material in the solid electrolyte composition is not particularly limited but is preferably 10% to 95% by mass, more preferably 30% to 90% by mass, still more preferably 50% to 85% by mass, and particularly preferably 55% to 80% by mass with respect to a solid content of 100% by mass.

Negative Electrode Active Material

A negative electrode active material that the solid electrolyte composition of the embodiment of the present invention may contain is preferably a negative electrode active material capable of reversibly intercalating and deintercalating lithium ions. The above-described material is not particularly limited as long as the material has the above-described characteristics, and examples thereof include a carbonaceous material, a metal oxide such as tin oxide, silicon oxide, a metal complex oxide, a lithium single body, a lithium alloy such as a lithium aluminum alloy, metals capable of forming alloys with lithium such as Sn, Si, Al, and In, and the like. Among these, a carbonaceous material or a lithium complex oxide is preferably used in terms of reliability. In addition, the metal complex oxide is preferably capable of intercalating and deintercalating lithium. The materials are not particularly limited but preferably contain titanium and/or lithium as constituent components from the viewpoint of high-current density charging and discharging characteristics.

The carbonaceous material that is used as the negative electrode active material is a material substantially consisting of carbon. Examples thereof include petroleum pitch, carbon black such as acetylene black (AB), graphite (natural graphite, artificial graphite such as highly oriented pyrolytic graphite), and a carbonaceous material obtained by firing a variety of synthetic resins such as polyacrylonitrile (PAN)-based resins or furfuryl alcohol resins. Furthermore, examples thereof also include a variety of carbon fibers such as PAN-based carbon fibers, cellulose-based carbon fibers, pitch-based carbon fibers, vapor-grown carbon fibers, dehydrated polyvinyl alcohol (PVA)-based carbon fibers, lignin carbon fibers, glassy carbon fibers, and active carbon fibers, mesophase microspheres, graphite whisker, flat graphite, and the like.

The metal oxides and the metal complex oxides being applied as the negative electrode active material are particularly preferably amorphous oxides, and furthermore, chalcogenides which are reaction products between a metal element and an element belonging to Group XVI of the periodic table are also preferably used. The amorphous oxides mentioned herein refer to oxides having a broad scattering band having a peak of a 2θ value in a range of 20° to 40° in an X-ray diffraction method in which CuKα rays are used and may have crystalline diffraction lines.

In a compound group consisting of the amorphous oxides and the chalcogenides, amorphous oxides of semimetal elements and chalcogenides are more preferred, and elements belonging to Groups XIII (IIIB) to XV (VB) of the periodic table, oxides consisting of one element or a combination of two or more elements of Al, Ga, Si, Sn, Ge, Pb, Sb, and Bi, and chalcogenides are particularly preferred. Specific examples of preferred amorphous oxides and chalcogenides include Ga₂O₃, SiO, GeO, SnO, SnO₂, PbO, PbO₂, Pb₂O₃, Pb₂O₄, Pb₃O₄, Sb₂O₃, Sb₂O₄, Sb₂O₈Bi₂O₃, Sb₂O₈Si₂O₃, Bi₂O₄, SnSiO₃, GeS, SnS, SnS₂, PbS, PbS₂, Sb₂S₃, Sb₂S₅, and SnSiS₃. In addition, these amorphous oxides may be complex oxides with lithium oxide, for example, Li₂SnO₂.

The negative electrode active material preferably contains a titanium atom. More specifically, Li₄Ti₅O₁₂ (lithium titanium oxide [LTO]) is preferred since the volume fluctuation during the absorption and deintercalation of lithium ions is small, and thus the high-speed charging and discharging characteristics are excellent, and the deterioration of electrodes is suppressed, whereby it becomes possible to improve the service lives of lithium ion secondary batteries.

In the present invention, a Si-based negative electrode is also preferably applied. Generally, a Si negative electrode is capable of intercalating a larger number of Li ions than a carbon negative electrode (graphite, acetylene black, or the like). That is, the amount of Li ions intercalated per unit mass increases. Therefore, it is possible to increase the battery capacity. As a result, there is an advantage that the battery driving duration can be extended.

The shape of the negative electrode active material is not particularly limited but is preferably a particle shape. The average particle diameter of the negative electrode active material is preferably 0.1 to 60 μm. In order to provide a predetermined particle diameter, an ordinary crusher or classifier is used. For example, a mortar, a ball mill, a sand mill, an oscillatory ball mill, a satellite ball mill, a planetary ball mill, a revolving airflow-type jet mill, a sieve, or the like is preferably used. During crushing, it is also possible to carry out wet-type crushing in which water or an organic solvent such as methanol is made to coexist as necessary. In order to provide a desired particle diameter, classification is preferably carried out. The classification method is not particularly limited, and it is possible to use a sieve, a wind power classifier, or the like depending on the necessity. Both of dry-type classification and wet-type classification can be carried out. The average particle diameter of negative electrode active material particles can be measured using the same method as the method for measuring the volume-average particle diameter of the positive electrode active material.

The chemical formulae of the compounds obtained using a firing method can be calculated using an inductively coupled plasma (ICP) emission spectroscopic analysis method as a measurement method from the mass difference of powder before and after firing as a convenient method.

The negative electrode active material may be used singly, or two or more types thereof may be used in combination.

In the case of forming a negative electrode active material layer, the mass (mg) of the negative electrode active material per unit area (cm²) in the negative electrode active material layer (weight per unit area) is not particularly limited. The weight per unit area can be appropriately determined depending on a set battery capacity.

The content of the negative electrode active material in the solid electrolyte composition is not particularly limited but is preferably 10% to 80% by mass and more preferably 20% to 80% by mass with respect to a solid content of 100% by mass.

The surfaces of the positive electrode active material and the negative electrode active material may be coated with different metal oxides. Examples of the surface coating agents include a metal oxide and the like containing Ti, Nb, Ta, W, Zr, Al, Si, or Li. Specific examples thereof include titanium oxide spinel, tantalum-based oxides, niobium-based oxides, lithium niobate-based compounds, and the like, and specific examples thereof include Li₄Ti₅O₁₂, Li₂Ti₂O₅, LiTaO₃, LiNbO₃, LiAlO₂, Li₂ZrO₃, Li₂WO₄, Li₂TiO₃, Li₂B₄O₇, Li₃PO₄, Li₂MoO₄, Li₃BO₃, LiBO₂, Li₂CO₃, Li₂SiO₃, SiO₂, TiO₂, ZrO₂, Al₂O₃, B₂O₃, and the like.

In addition, a surface treatment may be carried out on the surfaces of electrodes including the positive electrode active material or the negative electrode active material using sulfur, phosphorous, or the like.

Furthermore, the particle surface of the positive electrode active material or the negative electrode active material may be treated with an active light ray or an active gas (plasma or the like) before or after the coating of the surfaces.

(Conductive Auxiliary Agent (F))

The solid electrolyte composition of the embodiment of the present invention may further contain a conductive auxiliary agent. The conductive auxiliary agent is not particularly limited, and conductive auxiliary agents that are known as ordinary conductive auxiliary agents can be used. The conductive auxiliary agent may be, for example, graphite such as natural graphite or artificial graphite, carbon black such as acetylene black, Ketjen black, or furnace black, irregular carbon such as needle cokes, carbon fibers such as a vapor-grown carbon fiber, a carbon nanotube, and carbon nanofiber, or a carbonaceous material such as graphene or fullerene which are electron-conductive materials and also may be metal powder or a metal fiber of copper, nickel, or the like, and a conductive polymer such as polyaniline, polypyrrole, polythiophene, polyacetylene, or a polyphenylene derivative may also be used. In addition, these conductive auxiliary agents may be used singly or two or more conductive auxiliary agents may be used.

The content of the conductive auxiliary agent is preferably 0.1 parts by mass or more and more preferably 1 part by mass or more with respect to 100 parts by mass of the inorganic solid electrolyte. The upper limit is preferably 10 parts by mass or less and more preferably 5 parts by mass or less.

(Lithium Salt (G))

The solid electrolyte composition of the embodiment of the present invention may further contain a lithium salt (Li salt).

As the lithium salt that can be used in the present invention, a lithium salt that is usually used in this type of product is preferable. The lithium salt is not particularly limited, but for example, the following salts are preferable.

Inorganic lithium salts (L-1): inorganic fluoride salts such as LiPF₆, LiBF₄, LiAsF₆, and LiSbF₆; perhalogenates such as LiClO₄, LiBrO₄ and LiIO₄; inorganic chloride salts such as LiAlCl₄, and the like.

Fluorine-containing organic lithium salts (L-2): perfluoroalkane sulfonates such as LiCF₃SO₃; perfluoroalkanesulfonylimide salt LiN(CF₃SO₂)₂(LiTFSI), LiN(CF₃CF₂SO₂)₂, LiN(FSO₂)₂, LiN(CF₃SO₂)(C₄F₉SO₂); perfluoroalkane sulfonylmethide salts such as LiC(CF₃SO₂)₃; fluoroalkyl fluorophosphates such as Li[PF₅(CF₂CF₂CF₃)], Li[PF₄(CF₂CF₂CF₃)₂], Li[PF₃(CF₂CF₂CF₃)₃], Li[PF₅(CF₂CF₂CF₂CF₃)], Li[PF₄(CF₂CF₂CF₂CF₃)₂], Li[PF₃(CF₂CF₂CF₂CF₃)₃], and the like.

Oxalatoborate salts (L-3): lithium bis(oxalato)borate, lithium difluorooxalato borate, and the like.

Among these, LiPF₆, LiBF₄, LiAsF₆, LiSbF₆, LiClO₄, Li(Rf¹SO₃), LiN(Rf¹SO₂)₂, LiN(FSO₂)₂, and LiN(Rf¹SO₂)(Rf²SO₂) are preferable, and lithium imide salts such as LiPF₆, LiBF₄, LiN(Rf¹SO₂)₂, LiN(FSO₂)₂, and LiN(Rf¹SO₂)(Rf²SO₂) are more preferable. Here, Rf¹ and Rf² each represent a perfluoroalkyl group.

In addition, the lithium salt may be used singly, or two or more types thereof may be randomly combined.

The content of the lithium salt is preferably 0.1 parts by mass or more and more preferably 0.5 parts by mass or more with respect to 100 parts by mass of the inorganic solid electrolyte. The upper limit is preferably 10 parts by mass or less and more preferably 5 parts by mass or less.

<Other Binders>

The solid electrolyte composition of the embodiment of the present invention may contain a binder commonly used in an all-solid state secondary battery in addition to the above-mentioned binder (B) as long as the effects of the present invention are not impaired.

As the commonly used binder, an organic polymer is mentioned, and for example, binders constituted of resins described below are preferably used.

Examples of the fluorinated resins include polytetrafluoroethylene (PTFE), polyvinylene difluoride (PVdF), and a copolymer of polyvinylene difluoride and hexafluoropropylene (PVdF-HFP).

Examples of the hydrocarbon-based thermoplastic resins include polyethylene, polypropylene, styrene-butadiene rubber (SBR), hydrogenated styrene-butadiene rubber (HSBR), butylene rubber, acrylonitrile-butadiene rubber, polybutadiene, and polyisoprene. Examples of the acrylic resins include various (meth)acrylic monomers, (meth)acrylamide monomers, and copolymers (preferably, a copolymer of acrylic acid and methyl acrylate) of monomers constituting these resins.

In addition, copolymers with other vinyl monomers are also preferably used.

Examples of other resins include polyurethane resin, a polyurea resin, a polyamide resin, a polyimide resin, a polyester resin, a polyether resin, a polycarbonate resin, and a cellulose derivative resin.

This resin may be used singly, or two or more types thereof may be used in combination.

A commercial product can be used for the binder. In addition, a binder can also be prepared by a conventional method.

<Dispersant>

The solid electrolyte composition of the embodiment of the present invention may contain a dispersant. The containing of the dispersant enables the suppression of the agglomeration of the electrode active material and the inorganic solid electrolyte, even in a case where the concentration of any one of the electrode active material or the inorganic solid electrolyte is high or even in a case where the particle diameter is small and the surface area of the particles increases, the aggregation of the particles can be suppressed, and a uniform active material layer and solid electrolyte layer can be formed. As the dispersant, a dispersant that is generally used for an all-solid state secondary battery can be appropriately selected and used. Generally, a compound intended for particle adsorption and steric repulsion and/or electrostatic repulsion is preferably used.

(Preparation of Solid Electrolyte Composition)

As one example of a preparation method for the solid electrolyte composition of the embodiment of the present invention, a method in which the inorganic solid electrolyte (A) and the binder (B) are dispersed in the presence of the dispersion medium (C) and the solvent (D) to produce a slurry.

The slurry can be produced by mixing the inorganic solid electrolyte (A), the binder (B), the dispersion medium (C), and the solvent (D) using a variety of mixers. The mixing device is not particularly limited, and examples thereof include a ball mill, a beads mill, a planetary mixer, a blade mixer, a roll mill, a kneader, and a disc mill. The mixing conditions are not particularly limited, but in a case of using a ball mill, the inorganic solid electrolyte and the dispersion medium are preferably mixed at 150 to 700 rpm (rotation per minute) for 1 hour to 24 hours.

In the case of preparing a solid electrolyte composition containing components such as the active material and a dispersant, the components may be added and mixed simultaneously with a dispersion step of the inorganic solid electrolyte (A) and the binder (B) or may be separately added and mixed. The binder (B) may be separately added and mixed with the step of dispersing the inorganic solid electrolyte (A). The form of the binder polymer used for preparing the solid electrolyte composition of the embodiment of the present invention may be the binder polymer itself, a solution of the binder polymer, or a dispersion liquid of the binder polymer. Among these, a dispersion liquid of binder polymer having a particle shape is preferable from the viewpoint that decomposition of the inorganic solid electrolyte is suppressed and ion conductivity is ensured by being scattered on the particle surfaces of the active material and the inorganic solid electrolyte. In a case where a dispersion liquid of the binder polymer is used, the volume-average particle diameter of the binder polymer is preferably 10 to 10,000 nm, more preferably from 50 to 5,000 nm, and still more preferably 100 to 1,000 nm.

[Solid Electrolyte-Containing Sheet]

The solid electrolyte-containing sheet of the embodiment of the present invention contains at least the inorganic solid electrolyte (A) and the binder (B).

The solid electrolyte-containing sheet of the embodiment of the present invention has high ion conductivity while having excellent indentation strength due to excellent binding property between solid particles. The reason for this is not clear but is considered as follows. That is, because the binder (B) and the solvent (D) interact and coordinate with the functional groups on the surface of the solid electrolyte, the increase in particle diameter of the inorganic solid electrolyte particles can be avoided by suppressing the re-aggregation of the inorganic solid electrolyte during the preparation of the solid electrolyte composition. In addition, because the binder polymer having an acyclic siloxane structure hardly inhibits ion conduction, it is possible to suppress the increase in resistance due to the containing of the binder (B) in the solid electrolyte layer and the positive electrode active material layer. Accordingly, the use of the binder (B) and the solvent (D) in combination contributes to the improvement of binding property between the inorganic solid electrolytes while improving the ion conductivity of the solid electrolyte-containing sheet formed of the solid electrolyte composition of the embodiment of the present invention. As a result, the solid electrolyte-containing sheet of the embodiment of the present invention is considered to have high indentation strength and excellent lithium ion conductivity.

In addition, in a case where the binder polymer contained in the solid electrolyte-containing sheet of the embodiment of the present invention has a particle shape and has a volume-average particle diameter of 10 to 1,000 nm or less, it is considered that the binder polymer wets and spreads on the solid surface as the dispersion medium (C) and the solvent (D) are removed in the process of forming the solid electrolyte-containing sheet of the embodiment of the present invention from the solid electrolyte composition of the embodiment of the present invention. At this time, since the average particle diameter of the binder polymer is small, it is presumed that the binder polymer wets and spreads without completely covering the surface of the solid particles, and the inhibition of ion conductivity can be greatly reduced while exhibiting the effect of the binding property described above. As a result, the solid electrolyte-containing sheet of the embodiment of the present invention containing the binder having the above-described average particle diameter can achieve both the binding property and the ion conductivity at a higher level, the solid electrolyte-containing sheet of the embodiment of the present invention exhibits excellent mechanical strength (indentation strength), and an all-solid state secondary battery having the solid electrolyte-containing sheet are considered to exhibit high battery voltage.

The solid electrolyte-containing sheet of the embodiment of the present invention can be preferably used in all-solid state secondary batteries and is modified in a variety of aspects depending on the uses. Examples thereof include a sheet that is preferably used in a solid electrolyte layer (also referred to as a solid electrolyte sheet for an all-solid state secondary battery or solid electrolyte sheet), a sheet that is preferably used in an electrode or a laminate of an electrode and a solid electrolyte layer (an electrode sheet for an all-solid state secondary battery), and the like.

The solid electrolyte-containing sheet may be a sheet having a solid electrolyte layer and/or an active material layer (electrode layer), a sheet having a solid electrolyte layer and/or an active material layer (electrode layer) formed on a base material, or a sheet (sheet not having a base material) formed of a solid electrolyte layer and/or an active material layer (electrode layer) without having a base material. Hereinafter, a sheet having an aspect having a solid electrolyte layer or an active material layer (electrode layer) on a base material will be described in detail.

This solid electrolyte-containing sheet may further have other layers as long as the sheet has the base material and the solid electrolyte layer and/or the active material layer, but a sheet containing an active material is classified into an electrode sheet for an all-solid state secondary battery described below. Examples of other layers include a protective layer, a collector, a coating layer (a collector, a solid electrolyte layer, or an active material layer), and the like.

Examples of the solid electrolyte sheet for an all-solid state secondary battery include a sheet having a solid electrolyte layer and a protective layer on a base material in this order.

The base material is not particularly limited as long as the base material is capable of supporting the solid electrolyte layer, and examples thereof include sheet bodies (plate-like bodies) of materials, organic materials, inorganic materials, and the like described in the section of the collector described below. Examples of the organic materials include a variety of polymers and the like, and specific examples thereof include polyethylene terephthalate, polypropylene, polyethylene, cellulose, and the like. Examples of the inorganic materials include glass, ceramic, and the like.

The layer thickness of the solid electrolyte layer of the solid electrolyte-containing sheet is identical to the layer thickness of the solid electrolyte layer according to the preferred embodiment of the present invention described in the section of an all-solid state secondary battery.

The electrode sheet for an all-solid state secondary battery of the embodiment of the present invention (also simply referred to as “electrode sheet”. The electrode sheet for a positive electrode may be referred to as the “positive electrode sheet”, and the electrode sheet for a negative electrode may be referred to as a “negative electrode sheet”.) is used to form an active material layer of the all-solid state secondary battery and has an active material layer on a metal foil as a collector. This electrode sheet is generally a sheet having a collector and an active material layer, and an aspect of having a collector, an active material layer, and a solid electrolyte layer in this order and an aspect of having a collector, an active material layer, a solid electrolyte layer, and an active material layer in this order are also considered as the electrode sheet.

The layer thicknesses of the respective layers constituting the electrode sheet are identical to the layer thicknesses of individual layers described in the section of an all-solid state secondary battery according to the preferred embodiment of the present invention.

[All-Solid State Secondary Battery]

An all-solid state secondary battery of the embodiment of the present invention has a positive electrode, a negative electrode facing the positive electrode, and a solid electrolyte layer between the positive electrode and the negative electrode. The positive electrode has a positive electrode active material layer on a positive electrode collector. The negative electrode has a negative electrode active material layer on a negative electrode collector.

At least one layer of the negative electrode active material layer, the positive electrode active material layer, or the solid electrolyte layer is formed using the solid electrolyte composition of the embodiment of the present invention. In addition, at least one layer of the negative electrode active material layer, the positive electrode active material layer, or the solid electrolyte layer is the solid electrolyte-containing sheet of the embodiment of the present invention.

In the active material layer and/or the solid electrolyte layer formed by using the solid electrolyte composition, the kinds of the components being contained and content ratios thereof are preferably basically the same as the solid content of the solid electrolyte composition, unless otherwise specified.

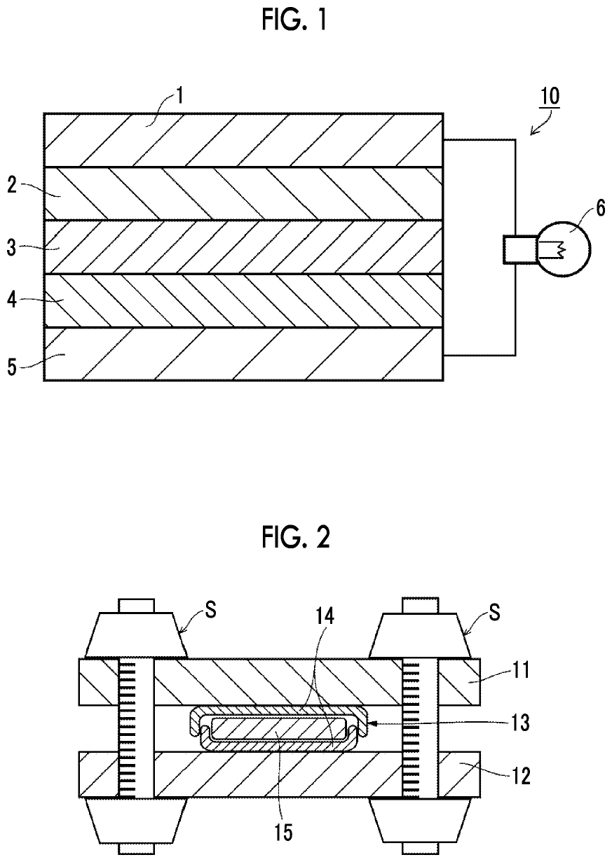

Hereinafter, the preferred embodiments of the present invention will be described with reference to FIG. 1, but the present invention is not limited thereto.

FIG. 1 is a cross-sectional view schematically illustrating an all-solid state secondary battery (lithium ion secondary battery) according to a preferred embodiment of the present invention. In case of being seen from the negative electrode side, an all-solid state secondary battery 10 of the present embodiment has a negative electrode collector 1, a negative electrode active material layer 2, a solid electrolyte layer 3, a positive electrode active material layer 4, and a positive electrode collector 5 in this order. Each layer is in contact with each other forms a laminated structure. In a case where the above-described structure is employed, during charging, electrons (e⁻) are supplied to the negative electrode side, and lithium ions (Li⁺) are accumulated on the negative electrode side. On the other hand, during discharging, the lithium ions (Li⁺) accumulated on the negative electrode side return to the positive electrode, and electrons are supplied to an operation portion 6. In an example illustrated in the drawing, an electric bulb is employed as the operation portion 6 and is lit by discharging. The solid electrolyte composition of the embodiment of the present invention can be preferably used as a forming material the negative electrode active material layer, the positive electrode active material layer, and the solid electrolyte layer. In addition, the solid electrolyte-containing sheet of the embodiment of the present invention is preferred as the negative electrode active material layer, the positive electrode active material layer, and the solid electrolyte layer.

In the present specification, the positive electrode active material layer (hereinafter, also referred to as the positive electrode layer) and the negative electrode active material layer (hereinafter, also referred to as the negative electrode layer) will be collectively referred to as the electrode layer or the active material layer in some cases.

The thicknesses of the positive electrode active material layer 4, the solid electrolyte layer 3, and the negative electrode active material layer 2 are not particularly limited. In a case where the dimensions of ordinary batteries are taken into account, the thicknesses are preferably 10 to 1,000 μm and more preferably 20 μm or more and less than 500 μm. In the all-solid state secondary battery of the embodiment of the present invention, the thickness of at least one layer of the positive electrode active material layer 4, the solid electrolyte layer 3, or the negative electrode active material layer 2 is still more preferably 50 μm or more and less than 500 μm.

[Positive Electrode Active Material Layer, Solid Electrolyte Layer, and Negative Electrode Active Material Layer]

In the all-solid state secondary battery 10, at least one of the positive electrode active material layer, the solid electrolyte layer, or the negative electrode active material layer is produced using the solid electrolyte composition of the embodiment of the present invention.

That is, in a case where the solid electrolyte layer 3 is produced using the solid electrolyte composition of the embodiment of the present invention, the solid electrolyte layer 3 includes the inorganic solid electrolyte (A) and the binder (B). The solid electrolyte layer, commonly, does not include positive electrode active material and/or negative electrode active material.

In a case where the positive electrode active material layer 4 and/or the negative electrode active material layer 2 is produced using the solid electrolyte composition of the embodiment of the present invention which contains the active material, the positive electrode active material layer 4 and the negative electrode active material layer 2 each include a positive electrode active material or a negative electrode active material and further include the inorganic solid electrolyte (A) and the binder (B). In a case where the active material layers contain the inorganic solid electrolyte, it is possible to improve the ion conductivity.

The kinds of the inorganic solid electrolyte (A) and the binder (B) that the positive electrode active material layer 4, the solid electrolyte layer 3, and the negative electrode active material layer 2 contain may be identical to or different from each other.

[Collector (Metal Foil)]

The positive electrode collector 5 and the negative electrode collector 1 are preferably an electron conductor.

In the present invention, there are cases in which any or both of the positive electrode collector and the negative electrode collector will be simply referred to as the collector.

As a material forming the positive electrode collector, aluminum, an aluminum alloy, stainless steel, nickel, titanium, or the like, and furthermore, a material obtained by treating the surface of aluminum or stainless steel with carbon, nickel, titanium, or silver (a material forming a thin film) is preferred, and, among these, aluminum and an aluminum alloy are more preferred.

As a material forming the negative electrode collector, aluminum, copper, a copper alloy, stainless steel, nickel, titanium, or the like, and furthermore, a material obtained by treating the surface of aluminum, copper, a copper alloy, or stainless steel with carbon, nickel, titanium, or silver is preferred, and aluminum, copper, a copper alloy, or stainless steel is more preferred.

Regarding the shape of the collector, generally, collectors having a film sheet-like shape are used, but it is also possible to use net-shaped collectors, punched collectors, compacts of lath bodies, porous bodies, foaming bodies, or fiber groups, and the like.

The thickness of the collector is not particularly limited but is preferably 1 to 500 μm. In addition, the surface of the collector is preferably provided with protrusions and recesses by means of surface treatment.

In the present invention, a functional layer, a functional member, or the like may be appropriately interposed or disposed between each layer of the negative electrode collector, the negative electrode active material layer, the solid electrolyte layer, the positive electrode active material layer, and the positive electrode collector or on the outside thereof. In addition, each layer may be constituted of a single layer or multiple layers.

[Chassis]

It is possible to produce the basic structure of the all-solid state secondary battery by disposing of each of the layers described above. Depending on the use, the basic structure may be directly used as an all-solid state secondary battery, but the basic structure may be used after being enclosed in an appropriate chassis in order to have a dry battery form. The chassis may be a metallic chassis or a resin (plastic) chassis. In a case where a metallic chassis is used, examples thereof include an aluminum alloy chassis and a stainless-steel chassis. The metallic chassis is preferably classified into a positive electrode-side chassis and a negative electrode-side chassis and electrically connected to the positive electrode collector and the negative electrode collector respectively. The positive electrode-side chassis and the negative electrode-side chassis are preferably integrated by being joined together through a gasket for short circuit prevention.

[Manufacturing of Solid Electrolyte-Containing Sheet]

The solid electrolyte-containing sheet of the embodiment of the present invention is obtained by making a film of the solid electrolyte composition of the embodiment of the present invention (by means of application and drying) on the base material (possibly, through other layers) and forming a solid electrolyte layer on the base material.

According to the above aspect, a solid electrolyte-containing sheet having the inorganic solid electrolyte (A) and the binder (B) on the base material can be produced. Further, the base material can be peeled off from the produced solid electrolyte-containing sheet to produce a solid electrolyte-containing sheet constituted of the solid electrolyte layer. In addition, the solid electrolyte layer described in the method for manufacturing an all-solid state secondary battery described later is also included in the solid electrolyte-containing sheet of the embodiment of the present invention.

Additionally, regarding steps such as coating, it is possible to use a method described in the following section of the manufacturing of an all-solid state secondary battery.

The solid electrolyte-containing sheet may contain the dispersion medium (C) and/or the solvent (D) as long as the battery performance is not affected. Specifically, the content thereof may be 1 ppm or more and 10,000 ppm or less of the total mass. In addition, the electrode sheet for an all-solid state secondary battery may also contain the dispersion medium (C) and/or the solvent (D) as long as the battery performance is not affected. Specifically, the content thereof may be 1 ppm or more and 10,000 ppm or less of the total mass.

The content ratio of the dispersion medium (C) and/or the solvent (D) in the solid electrolyte-containing sheet of the embodiment of the present invention can be measured by the following method.

The solid electrolyte-containing sheet is punched out into a 20 mm square, and immersed in heavy tetrahydrofuran in a glass bottle. The eluate obtained is filtered through a syringe filter and quantitation operation is performed by ¹H-NMR. The correlation between the ¹H-NMR peak area and the amount of the solvent is determined by preparing a calibration curve.

[Manufacturing of All-Solid State Secondary Battery And Electrode Sheet for All-Solid State Secondary Battery]

The all-solid state secondary battery and the electrode sheet for an all-solid state secondary battery can be manufactured using an ordinary method. Specifically, the all-solid state secondary battery and the electrode sheet for an all-solid state secondary battery can be manufactured by forming each of the layers described above using the solid electrolyte composition of the embodiment of the present invention or the like. The details of manufacturing will be described below.

The all-solid state secondary battery of the embodiment of the present invention can be manufactured using a method including (through) a step of applying the solid electrolyte composition of the embodiment of the present invention onto base material (for example, a metal foil which serves as a collector) and forming a coating film (making a film).

For example, a solid electrolyte composition containing a positive electrode active material is applied as a material for a positive electrode (a composition for a positive electrode) onto a metal foil which is a positive electrode collector so as to form a positive electrode active material layer, thereby producing a positive electrode sheet for an all-solid state secondary battery. Next, a solid electrolyte composition for forming a solid electrolyte layer is applied onto the positive electrode active material layer so as to form a solid electrolyte layer. Further, a solid electrolyte composition containing a negative electrode active material is applied as a material for a negative electrode (a composition for a negative electrode) onto the solid electrolyte layer so as to form a negative electrode active material layer. A negative electrode collector (a metal foil) is overlaid on the negative electrode active material layer, whereby it is possible to obtain an all-solid state secondary battery having a structure in which the solid electrolyte layer is sandwiched between the positive electrode active material layer and the negative electrode active material layer. A desired all-solid state secondary battery can be produced by enclosing the all-solid state secondary battery in a chassis as necessary.

In addition, it is also possible to manufacture an all-solid state secondary battery by carrying out the methods for forming individual layers in a reverse order so as to form a negative electrode active material layer, a solid electrolyte layer, and a positive electrode active material layer on a negative electrode collector and overlaying a positive electrode collector thereon.

As another method, the following method can be exemplified. That is, a positive electrode sheet for an all-solid state secondary battery is produced as described above. In addition, a solid electrolyte composition containing a negative electrode active material is applied as a material for a negative electrode (a composition for a negative electrode) onto a metal foil which is a negative electrode collector so as to form a negative electrode active material layer, thereby producing a negative electrode sheet for an all-solid state secondary battery. Next, a solid electrolyte layer is formed on the active material layer of any one of these sheets as described above. Furthermore, the other one of the positive electrode sheet for an all-solid state secondary battery and the negative electrode sheet for an all-solid state secondary battery is laminated on the solid electrolyte layer so that the solid electrolyte layer and the active material layer come into contact with each other. An all-solid state secondary battery can be manufactured as described above.

As still another method, the following method can be exemplified. That is, a positive electrode sheet for an all-solid state secondary battery and a negative electrode sheet for an all-solid state secondary battery are produced as described above. In addition, separately from the positive electrode sheet for an all-solid state secondary battery and the negative electrode sheet for an all-solid state secondary battery, a solid electrolyte composition is applied onto a base material, thereby producing a solid electrolyte sheet for an all-solid state secondary battery consisting of a solid electrolyte layer. Further, the positive electrode sheet for an all-solid state secondary battery and the negative electrode sheet for an all-solid state secondary battery are laminated together so as to sandwich the solid electrolyte layer that has been peeled off from the base material. An all-solid state secondary battery can be manufactured as described above.

An all-solid state secondary battery can be manufactured by combining the above-described forming methods. For example, a positive electrode sheet for an all-solid state secondary battery, a negative electrode sheet for an all-solid state secondary battery, and a solid electrolyte sheet for an all-solid state secondary battery are produced individually. Next, a solid electrolyte layer peeled off from a base material is laminated on the negative electrode sheet for an all-solid state secondary battery and is then attached to the positive electrode sheet for an all-solid state secondary battery, whereby an all-solid state secondary battery can be manufactured. In this method, it is also possible to laminate the solid electrolyte layer on the positive electrode sheet for an all-solid state secondary battery and attach the solid electrolyte layer to the negative electrode sheet for an all-solid state secondary battery.

Similarly to the above-mentioned solid electrolyte sheet, the electrode sheet for an all-solid state secondary battery of the embodiment of the present invention includes a configuration having no base material.

(Formation of Individual Layers (Film Formation))

The method for applying the solid electrolyte composition is not particularly limited and can be appropriately selected. Examples thereof include coating (preferably wet-type coating), spray coating, spin coating, dip coating, slit coating, stripe coating, and bar coating.

At this time, the solid electrolyte composition may be dried after being applied or may be dried after being applied to multiple layers. The drying temperature is not particularly limited. The lower limit is preferably 30° C. or higher, more preferably 60° C. or higher, and still more preferably 80° C. or higher. The upper limit is preferably 300° C. or lower, more preferably 250° C. or lower, and still more preferably 200° C. or lower. In a case where the compositions are heated in the above-described temperature range, it is possible to remove the dispersion medium (C) and the solvent (D) and form a solid state. This temperature range is preferable since the temperature is not excessively increased and each member of the all-solid state secondary battery is not impaired. Therefore, in the all-solid state secondary battery, excellent total performance is exhibited, and it is possible to obtain a favorable binding property.

After the production of the solid electrolyte-containing sheet or the all-solid state secondary battery, each of the layers or the all-solid state secondary battery is preferably pressurized. In addition, each of the layers is also preferably pressurized together in a state of being laminated. Examples of the pressurization method include a method using a hydraulic cylinder pressing machine and the like. The welding pressure is not particularly limited, but is, generally, preferably in a range of 50 to 1,500 MPa.

In addition, the applied solid electrolyte composition may be heated at the same time as pressurization. The heating temperature is not particularly limited but is generally in a range of 30° C. to 300° C. Each of the layers or the all-solid state secondary battery can also be pressed at a temperature higher than the glass transition temperature of the inorganic solid electrolyte.

The pressurization may be carried out in a state in which the dispersion medium (C) and the solvent (D) have been dried in advance or in a state in which the dispersion medium (C) and the solvent (D) remains.

The individual compositions may be applied at the same time, and the application, the drying, and the pressing may be carried out simultaneously and/or sequentially. The individual compositions may be applied to separate base materials and then laminated by transferring.

The atmosphere during the pressurization is not particularly limited and may be any one of the atmosphere such as an atmosphere under the dried air (the dew point: −20° C. or lower), in an inert gas (for example, in an argon gas, in a helium gas, or in a nitrogen gas), and the like.

The pressurization time may be a short time (for example, within several hours) under the application of a high pressure or a long time (one day or longer) under the application of an intermediate pressure. In the case of members other than the sheet for an all-solid state secondary battery, for example, the all-solid state secondary battery, it is also possible to use a restraining device (screw fastening pressure or the like) of the all-solid state secondary battery in order to continuously apply an intermediate pressure.

The pressing pressure may be a pressure that is constant or varies with respect to a portion under pressure such as a sheet surface.

The pressing pressure can be changed depending on the area or film thickness of the portion under pressure. In addition, it is also possible to change the pressure to a pressure that varies stepwise at the same portion.

A pressing surface may be flat or roughened.

(Initialization)

The all-solid state secondary battery manufactured as described above is preferably initialized after the manufacturing or before the use. The initialization is not particularly limited, and it is possible to initialize the all-solid state secondary battery by, for example, carrying out initial charging and discharging in a state in which the pressing pressure is increased and then releasing the pressure to a pressure at which the all-solid state secondary battery is ordinarily used.

[Usages of All-Solid State Secondary Battery]

The all-solid state secondary battery of the embodiment of the present invention can be applied to a variety of usages. Application aspects are not particularly limited, and, in the case of being mounted in electronic devices, examples thereof include notebook computers, pen-based input personal computers, mobile personal computers, e-book players, mobile phones, cordless phone handsets, pagers, handy terminals, portable faxes, mobile copiers, portable printers, headphone stereos, video movies, liquid crystal televisions, handy cleaners, portable CDs, mini discs, electric shavers, transceivers, electronic notebooks, calculators, portable tape recorders, radios, backup power supplies, memory cards, and the like. Additionally, examples of consumer usages include vehicles (electric cars and the like), electric vehicles, motors, lighting equipment, toys, game devices, road conditioners, watches, strobes, cameras, medical devices (pacemakers, hearing aids, shoulder massage devices, and the like), and the like. Furthermore, the all-solid state secondary battery can be used for a variety of military usages and universe usages. In addition, the all-solid state secondary battery can also be combined with a solar battery.

According to the preferred embodiment of the present invention, individual application configurations as described below are derived.

[1] All-solid state secondary battery in which all layers of a positive electrode active material layer, a solid electrolyte layer, and a negative electrode active material layer are the solid electrolyte-containing sheet of the embodiment of the present invention.

[2] All-solid state secondary battery in which at least one layer of a positive electrode active material layer, a solid electrolyte layer, or a negative electrode active material layer contains a lithium salt.

[3] A method for manufacturing an all-solid state secondary battery in which a solid electrolyte layer is made into a film by wet-type coating of a slurry in which a lithium salt and a sulfide-based inorganic solid electrolyte are dispersed with a dispersion medium and a solvent.

[4] A solid electrolyte composition containing an inorganic solid electrolyte, a binder, an active material, a dispersion medium, a solvent, and a lithium salt.

[5] An electrode sheet for an all-solid state secondary battery obtained by applying the solid electrolyte composition (for example, wet-type coating) onto a metal foil to make a film.

[6] A method for manufacturing an electrode sheet for an all-solid state secondary battery by applying (for example, wet-type coating) the solid electrolyte composition onto a metal foil to make a film.

As described in the preferred embodiments [3] and [6], preferred methods for manufacturing the all-solid state secondary battery and the electrode sheet for an all-solid state secondary battery of the embodiment of the present invention are all wet-type processes. Therefore, even in a region in at least one layer of the positive electrode active material layer or the negative electrode active material layer in which the content of the inorganic solid electrolyte is as low as 10% by mass or less, the adhesiveness between the active material and the inorganic solid electrolyte is improved, an efficient ion conduction path can be maintained, and it is possible to manufacture an all-solid state secondary battery having a high energy density (Wh/kg) and a high output density (W/kg) per battery mass.

All-solid state secondary batteries refer to secondary batteries having a positive electrode, a negative electrode, and an electrolyte, all of which are constituted of solid. In other words, all-solid state secondary batteries are differentiated from electrolytic solution-type secondary batteries in which a carbonate-based solvent is used as an electrolyte. Among these, the present invention is based on an inorganic all-solid state secondary battery. All-solid state secondary batteries are classified into organic (polymer) all-solid state secondary batteries in which a polymer compound such as polyethylene oxide is used as an electrolyte and inorganic all-solid state secondary batteries in which the Li—P—S-based glass, LLT, LLZ, or the like is used. Meanwhile, the application of organic compounds to inorganic all-solid state secondary batteries is not inhibited, and organic compounds can also be applied as binders or additives of positive electrode active materials, negative electrode active materials, and inorganic solid electrolytes.

Inorganic solid electrolytes are differentiated from electrolytes in which the above-described polymer compound is used as an ion conductive medium (polymer electrolyte), and inorganic compounds serve as ion conductive media. Specific examples thereof include the Li—P—S glass, LLT, and LLZ. Inorganic solid electrolytes do not deintercalate positive ions (Li ions) and exhibit an ion transportation function. In contrast, there are cases in which materials serving as an ion supply source which is added to electrolytic solutions or solid electrolyte layers and deintercalates positive ions (Li ions) are referred to as electrolytes. However, in the case of differentiating the materials from electrolytes as the ion transportation materials, the materials are referred to as “electrolyte salts” or “supporting electrolytes”. Examples of the electrolyte salts include LiTFSI.

In the present invention, “composition” refers to a mixture obtained by uniformly mixing two or more components. However, the composition may be partially aggregated or partially unevenly distributed as long as the composition substantially maintains uniformity and exhibits desired effects. Examples

Hereinafter, the present invention will be described in more detail on the basis of Examples. It is noted that the present invention is not interpreted to be limited thereto. “Parts” and “%” that represent compositions in the following Examples are mass-based unless particularly otherwise described. In addition, “room temperature” refers to 25° C. “-” in Tables means that the corresponding component is not contained.

<Synthesis of Sulfide-Based Inorganic Solid Electrolyte Li—P—S-Based Glass>

As a sulfide-based inorganic solid electrolyte, Li—P—S-based glass was synthesized with reference to a non-patent document of T. Ohtomo, A. Hayashi, M. Tatsumisago, Y. Tsuchida, S. Hama, K. Kawamoto, Journal of Power Sources, 233, (2013), pp. 231 to 235 and A. Hayashi, S. Hama, H. Morimoto, M. Tatsumisago, T. Minami, Chem. Lett., (2001), pp. 872 and 873.

Specifically, in a globe box under an argon atmosphere (dew point: −70° C.), lithium sulfide (Li₂S, manufactured by Aldrich-Sigma, Co. LLC. Purity: >99.98%) (2.42 g) and diphosphorus pentasulfide (P₂S₅, manufactured by Aldrich-Sigma, Co. LLC. Purity: >99%) (3.90 g) each were weighed, put into an agate mortar, and mixed using an agate muddler for five minutes. The mixing ratio of Li₂S to P₂S₅ was set to 75:25 (Li₂S:P₂S₅) in terms of molar ratio.

66 g of zirconia beads having a diameter of 5 mm were put into a 45 mL zirconia container (manufactured by Fritsch Japan Co., Ltd.), the total amount of the mixture of the lithium sulfide and the diphosphorus pentasulfide was put thereinto, and the container was perfectly sealed in an argon atmosphere. The container was set in a planetary ball mill P-7 (trade name, manufactured by Fritsch Japan Co., Ltd.), mechanical milling was carried out at a temperature of 25° C. and a rotation speed of 510 rpm for 20 hours, thereby obtaining yellow powder (6.20 g) of a sulfide-based inorganic solid electrolyte (Li—P—S-based glass, sometimes referred to as Li—P—S).

<Preparation Examples of Binder (B)>

Hereinafter, preparation examples of the binder (B) dispersion liquid or solution will be described. The average particle diameter of the binder is described only for the binders present in a particle shape in the dispersion medium.

(Preparation of binder (P-1))

7.50 g of X-22-174ASX (trade name, manufactured by Shin-Etsu Silicone Co., Ltd., M-1 described in the column of MC4 in Table 1) and 22.5 g of heptane were added to a 200 mL three-necked flask, and stirred to be dissolved uniformly at 80° C. Thus, solution A was obtained. Separately, in a 50 mL measuring cylinder, 10 g of hydroxybutyl acrylate (A-7 described in the column of MC1 in Table 1), 5.00 g of acrylic acid (A-8, MC2 in Table 1), and 2.50 g of ethyl acrylate (A-2 in described in the row of MC3 in Table 1), 0.25 g of V-601 (trade name, manufactured by Wako Pure Chemical Industries, Ltd.) and 14.0 g of heptane were added, and the mixture was stirred and uniformly dissolved. Thus, solution B was obtained. Solution B was added dropwise to solution A at 80° C. for 2 hours, and then stirring was further continued at 80° C. for 2 hours and at 90° C. for 2 hours to obtain a binder (P-1) latex. Mw was 106,000 and the volume-average particle diameter was 240 nm.

(Preparation of Binder (P-2))

A binder (P-2) latex was obtained in the same manner as in the preparation of the binder (P-1) except that MC1, MC2, MC3, and MC4 described in Table 1 below were used. Mw was 22,000 and the volume-average particle diameter was 180 nm.

(Preparation of Binder (P-3))

A binder (P-3) latex was obtained in the same manner as in the preparation of the binder (P-1) except that MC1, MC2, MC3, and MC4 described in Table 1 below were used. Mw was 58,000 and the volume-average particle diameter was 450 nm.

(Preparation of Binder (P-5))

A binder (P-5) latex was obtained in the same manner as in the preparation of the binder (P-1) except that MC1, MC2, and MC4 described in Table 1 below were used and diisopropyl ketone was used instead of heptane. Mw was 45,000 and the volume-average particle diameter was 230 nm.

(Preparation of Binder (P-6))

A binder (P-6) latex was obtained in the same manner as in the preparation of the binder (P-1) except that MC1, MC2, MC3, and MC4 described in Table 1 below were used and diisobutyl ketone was used instead of heptane. Mw was 92,000 and the volume-average particle diameter was 270 nm.

(Preparation of Binder (P-8))

A binder (P-8) latex was obtained in the same manner as in the preparation of the binder (P-1) except that MC1, MC2, and MC4 described in Table 1 below were used and diisobutyl ketone was used instead of heptane. Mw was 40,000 and the volume-average particle diameter was 280 nm.

(Preparation of Binder (P-9))

A binder (P-9) latex was obtained in the same manner as in the preparation of the binder (P-1) except that MC1, MC2, MC3, and MC4 described in Table 1 below were used and butyl butyrate was used instead of heptane. Mw was 37,000 and the volume-average particle diameter was 190 nm.

(Preparation of Binder (P-10))

A solution of binder (P-10) latex was obtained in the same manner as in the preparation of the binder (P-1) except that MC1 and MC4 described in Table 1 below were used and diisopropyl ketone was used instead of heptane. Mw was 29,000.

(Preparation of Binder (P-11))

A solution of binder (P-11) latex was obtained in the same manner as in the preparation of the binder (P-1) except that MC1 and MC4 described in Table 1 below were used and diisopropyl ketone was used instead of heptane. Mw was 25,000.

(Preparation of Binder (P-13))

A binder (P-13) solution was obtained in the same manner as in the preparation of the binder (P-1) except that MC1, MC2, MC3, and MC4 described in Table 1 below were used and diisopropyl ketone was used instead of heptane. Mw was 79,000.

(Preparation of Binder (P-14))

A solution of binder (P-14) latex was obtained in the same manner as in the preparation of the binder (P-1) except that MC1 and MC4 described in Table 1 below were used and diisopropyl ketone was used instead of heptane. Mw was 46,000.

(Preparation of Binder (P-15))

A binder (P-15) latex was obtained in the same manner as in the preparation of the polymer (P-1) except that MC1, MC2, MC3, and MC4 described in Table 1 below were used. Mw was 59,000 and the volume-average particle diameter was 180 nm.

(Preparation of Binder (P-16))

A binder (P-16) latex was obtained in the same manner as in the preparation of the binder (P-1) except that MC1, MC2, and MC4 described in Table 1 below were used. Mw was 34,000 and the volume-average particle diameter was 340 nm.

(Preparation of Binder (P-17))

A binder (P-17) latex was obtained in the same manner as in the preparation of the polymer (P-1) except that MC1, MC2, MC3, and MC4 described in Table 1 below were used. Mw was 31,000 and the volume-average particle diameter was 270 nm.

(Preparation of Binder (P-18))

A binder (P-18) latex was obtained in the same manner as in the preparation of the binder (P-1) except that MC1, MC2, MC3, and MC4 described in Table 1 below were used. Mw was 47,000 and the volume-average particle diameter was 260 nm.

(Preparation of Binder (P-4))

1.20 g of 1,4-butanediol (B-11 described in the column of MC2 in Table 1), 2.5 g of polycarbonate diol (trade name: Duranol T5650E manufactured by Asahi Kasei Corporation, Mw: 500, N-1 described in the column of MC3 in Table 1), and 13 g of KF-6000 (trade name, manufactured by Shin-Etsu Chemical Co., Ltd., M-4 described in the column of MC4 in Table 1) were added in a 300 mL three-necked flask and dissolved in 56 g of MEK (methylethyl ketone). To this solution, 7.5 g of methylenediphenyl 4,4′-diisocyanate (B-1 described in the column of MC1 in Table 1) was added, and the mixture was stirred to be dissolved uniformly at 80° C. To this solution, 100 mg of Neostan U-600 (trade name, manufactured by Nitto Kasei Co., Ltd.) was added and stirred at 80° C. for 8 hours to obtain a cloudy viscous polymer solution. 1 g of methanol was added to this solution to seal the terminal of the polymer, thereby terminating the polymerization reaction to obtain a MEK solution of a binder (P-4).

Next, while stirring the MEK solution of the binder (P-4) obtained above at 500 rpm, 96 g of octane was added dropwise over 1 hour to obtain an emulsion of the binder (P-4). This emulsion was heated at 85° C. for 120 minutes while flowing nitrogen. Further, 50 g of octane was added to the residual, and heating at 85° C. for 60 minutes was repeated four times similarly to remove MEK to obtain a dispersion liquid of a binder (P-4) having 10% by mass octane. Mw was 18,000 and the volume-average particle diameter was 200 nm.

(Preparation of Binder (P-7))

A binder (P-7) latex was obtained in the same manner as in the preparation of the binder (P-4) except that MC1, MC2, MC3, and MC4 described in Table 1 below were used. Mw was 33,000 and the volume-average particle diameter was 390 nm.

(Preparation of Binder (P-12))

A binder (P-12) latex was obtained in the same manner as in the preparation of the binder (P-4) except that MC1, MC2, MC3, and MC4 described in Table 1 below were used. Mw was 76,000 and the volume-average particle diameter was 440 nm.

TABLE 1

| | MC1 | | MC2 | | MC3 | | MC4 | | | Molecular | Form | |
|---|---|---|---|---|---|---|---|---|---|---|---|---|
| | | Parts | | Parts | | Parts | | Molecular | Parts | weight of | of | |
| Binder | | by | | by | | by | | weigh | by | binder (B) | binder | |
| (B) | | mass | | mass | | mass | | (Mw) | mass | (Mw) | (B) | Kind |
| P-1 | A-7 | 40 | A-8 | 20 | A-2 | 10 | M-1 | 900 | 30 | 106,000 | Particle | Acryl |
| P-2 | A-7 | 60 | A-19 | 10 | A-4 | 10 | M-2 | 2300 | 20 | 22,000 | Particle | Acryl |
| P-3 | A-23 | 20 | A-25 | 5 | A-22 | 50 | M-3 | 450 | 25 | 58,000 | Particle | Acryl |
| P-4 | B-1 | 30 | B-11 | 5 | N-1 | 10 | M-4 | 470 | 55 | 18,000 | Particle | Acryl |
| P-5 | A-6 | 60 | A-10 | 10 | — | 0 | M-6 | 4600 | 30 | 45,000 | Particle | Polyurethane |
| P-6 | A-7 | 55 | A-11 | 20 | A-34 | 5 | M-1 | 900 | 20 | 92,000 | Soluble | Acryl |
| P-7 | B-7 | 30 | B-11 | 5 | N-2 | 15 | M-4 | 470 | 50 | 33,000 | Particle | Acryl |
| P-8 | B-14 | 40 | B-10 | 4 | — | 0 | M-5 | 1600 | 56 | 40,000 | Particle | Polyurethane |
| P-9 | A-6 | 70 | A-12 | 10 | A-5 | 5 | M-3 | 450 | 15 | 37,000 | Particle | Polyester |
| P-10 | A-19 | 60 | — | 0 | — | 0 | M-6 | 4600 | 40 | 29,000 | Soluble | Acryl |
| P-11 | A-7 | 60 | — | 0 | — | 0 | M-6 | 4600 | 40 | 25,000 | Soluble | Acryl |
| P-12 | B-7 | 30 | B-11 | 5 | N-3 | 20 | M-4 | 470 | 45 | 76,000 | Particle | Polyurethane |
| P-13 | A-6 | 25 | A-10 | 45 | A-29 | 10 | M-2 | 2300 | 20 | 79,000 | Soluble | Acryl |
| P-14 | A-37 | 80 | — | 0 | — | 0 | M-6 | 4600 | 20 | 46,000 | Soluble | Acryl |
| P-15 | A-23 | 45 | A-24 | 10 | A-20 | 5 | M-1 | 900 | 40 | 59,000 | Particle | Acryl |
| P-16 | A-31 | 30 | A-27 | 30 | — | 0 | M-2 | 2300 | 40 | 34,000 | Particle | Acryl |
| P-17 | A-9 | 40 | A-19 | 32 | A-35 | 3 | M-6 | 4600 | 25 | 31,000 | Particle | Acryl |
| P-18 | A-7 | 60 | A-19 | 10 | A-4 | 10 | M-7 | 6000 | 20 | 47,000 | Particle | Acryl |

<Notes of table>
A-Number: Indicates the above-mentioned exemplary compound.
B-Number: Indicates the above-mentioned exemplary compound.
N-1: DURANOL T5650E (trade name, manufactured by Asahi Kasei Corporation)
N-2: DURANOL T5650J (trade name, manufactured by Asahi Kasei Corporation)
N-3: P-1010 (trade name, manufactured by Kuraray Co., Ltd.)
M-1: X-22-174ASX (trade name, manufactured by Shin-Etsu Silicone Co., Ltd.)
M-2: X-22-174BX (trade name, manufactured by Shin-Etsu Silicone Co., Ltd.)
M-3: X-22-164AS (trade name, manufactured by Shin-Etsu Silicone Co., Ltd.)
M-4: KF-6000 (trade name, manufactured by Shin-Etsu Silicone Co., Ltd.)
M-5: KF-6002 (trade name, manufactured by Shin-Etsu Silicone Co., Ltd.)
M-6: KF-2012 (trade name, manufactured by Shin-Etsu Silicone Co., Ltd.)
M-7: AB-6 (trade name, manufactured by Toagosei Co., Ltd., monomer having a butyl acrylate segment)
Parts by mass in Table above indicate parts by mass of the solid content.
M-1 to M-6 are compounds having a partial structure represented by Formula (I).

### EXAMPLE 1

<Preparation Example of Solid Electrolyte Composition>

180 zirconia beads having a diameter of 5 mm were put into a 45 mL zirconia container (manufactured by Fritsch Japan Co., Ltd.), an inorganic solid electrolyte, a binder, a dispersion medium, and a solvent were put into the container. The container was set in a planetary ball mill P-7 (trade name, manufactured by Fritsch Japan Co., Ltd.) and mixed at a rotation speed of 300 rpm at room temperature for 2 hours to prepare a solid electrolyte composition. In a case where the solid electrolyte composition contained an active material, the active material was put into the container and further mixed at a rotation speed of at 150 rpm at room temperature for 5 minutes to prepare a solid electrolyte composition. In a case where the solid electrolyte composition contained a conductive auxiliary agent, the inorganic solid electrolyte, the binder, the conductive auxiliary agent, the dispersion medium, and the solvent were put together into the planetary ball mill P-7 and mixed to prepare a solid electrolyte composition. In this way, solid electrolyte compositions No. S-1 to S-19 and T′-1 to T′-6 described in Table 2 below was were prepared.

Here, No. S-1 to S-19 are examples of the present invention, and No. T′-1 to T′-6 are comparative examples.

TABLE 2

| | Inorganic solid | | | | Active | | Conductive | | Lithium | | Dispersion | | | | |
|---|---|---|---|---|---|---|---|---|---|---|---|---|---|---|---|
| | electrolyte | | Binder | | material | | auxiliary | | salt | | medium | | | | |
| | (A) | | (B) | | (E) | | agent (C) | | (G) | | (C) | | Solvent (D) | | |
| | | Parts | | Parts | | Parts | | Parts | | Parts | | Parts | | Parts | |
| Com- | | by | | by | | by | | by | | by | | by | | by | |
| ponent | | mass | | mass | | mass | | mass | | mass | | mass | | mass | Notes |
| S-1 | LLT | 45 | P-1 | 7 | Not | 0 | Not | 0 | Not | 0 | Octane | 43.2 | Diisopropyl | 4.8 | Present |
| | | | | | included | | included | | included | | | | ketone | | invention |
| S-2 | Li-P-S | 45 | P-2 | 7 | Not | 0 | Not | 0 | Not | 0 | Octane | 38.4 | Diisopropyl | 9.6 | Present |
| | | | | | included | | included | | included | | | | ketone | | invention |
| S-3 | Li-P-S | 10 | P-3 | 2 | NMC | 36 | AB | 2 | Not | 0 | Heptane | 40 | Isopropyl | 10 | Present |
| | | | | | | | | | included | | | | methane- | | invention |
| | | | | | | | | | | | | | sulfonate | | |
| S-4 | Li-P-S | 10 | P-4 | 2 | Graphite | 36 | Not | 0 | Not | 0 | Heptane | 41.6 | Isopropyl | 10.4 | Present |
| | | | | | | | included | | included | | | | methane- | | invention |
| | | | | | | | | | | | | | sulfonate | | |
| S-5 | Li-P-S | 10 | P-5 | 2 | NMC | 36 | AB | 2 | Not | 0 | Cyclo- | 40 | Diisobutyl | 10 | Present |
| | | | | | | | | | included | | hexane | | ketone | | invention |
| S-6 | Li-P-S | 10 | P-6 | 2 | Graphite | 36 | Not | 0 | Not | 0 | Cyclo- | 41.6 | Diisobutyl | 10.4 | Present |
| | | | | | | | included | | included | | hexane | | ketone | | invention |
| S-7 | Li-P-S | 10 | P-7 | 2 | NMC | 36 | AB | 2 | Not | 0 | Heptane | 40 | Propyl | 10 | Present |
| | | | | | | | | | included | | | | butyrate | | invention |
| S-8 | Li-P-S | 10 | P-8 | 2 | NMC | 36 | VGCF | 2 | Not | 0 | Heptane | 40 | Propyl | 10 | Present |
| | | | | | | | | | included | | | | butyrate | | invention |
| S-9 | Li-P-S | 10 | P-8 | 2 | NMC | 30 | VGCF | 2 | LiPF6 | 6 | Heptane | 44.8 | Propyl | 11.2 | Present |
| | | | | | | | | | | | | | butyrate | | invention |
| S-10 | Li-P-S | 10 | P-9 | 2 | NMC | 36 | VGCF | 2 | Not | 0 | Heptane | 40 | Fluorinert | 10 | Present |
| | | | | | | | | | included | | | | | | invention |
| S-11 | Li-P-S | 10 | P-10 | 2 | NMC | 36 | VGDF | 2 | Not | 0 | Heptane | 40 | Fluorinert | 10 | Present |
| | | | | | | | | | included | | | | | | invention |
| S-12 | Li-P-S | 10 | P-11 | 2 | NMC | 36 | VGDF | 2 | Not | 0 | Heptane | 40 | Fluorinert | 10 | Present |
| | | | | | | | | | included | | | | | | invention |
| S-13 | Li-P-S | 10 | P-12 | 2 | Graphite | 36 | Not | 0 | Not | 0 | Heptane | 41.6 | Dipropyl ether | 10.4 | Present |
| | | | | | | | included | | included | | | | | | invention |
| S-14 | Li-P-S | 10 | P-13 | 2 | Graphite | 36 | Not | 0 | Not | 0 | Heptane | 41.6 | Dipropyl ether | 10.4 | Present |
| | | | | | | | included | | included | | | | | | invention |
| S-15 | Li-P-S | 10 | P-13 | 2 | Graphite | 30 | Not | 0 | LiTFSI | 6 | Heptane | 46.4 | Dipropyl ether | 11.6 | Present |
| | | | | | | | included | | | | | | | | invention |
| S-16 | Li-P-S | 10 | P-14 | 2 | NCA | 36 | Not | 0 | Not | 0 | Heptane | 41.6 | Methylene | 10.4 | Present |
| | | | | | | | included | | | | | | chloride | | invention |
| S-17 | Li-P-S | 10 | P-15 | 2 | NCA | 36 | Not | 0 | Not | 0 | Heptane | 41.6 | Methylene | 10.4 | Present |
| | | | | | | | included | | included | | | | chloride | | invention |
| S-18 | Li-P-S | 10 | P-16 | 2 | NMC | 36 | VGCF | 2 | Not | 0 | Heptane | 30 | N,N- | 20 | Present |
| | | | | | | | | | included | | | | diisopuropyl- | | invention |
| | | | | | | | | | | | | | ethyleneamine | | |
| S-19 | Li-P-S | 10 | P-17 | 2 | NMC | 36 | VGCF | 2 | Not | 0 | Toluene | 30 | N,N- | 20 | Present |
| | | | | | | | | | included | | | | diisopuropyl- | | invention |
| | | | | | | | | | | | | | ethyleneamine | | |
| T′-1 | Li-P-S | 10 | P-1 | 2 | NMC | 36 | AB | 2 | Not | 0 | Heptane | 40 | Toluene | 10 | Com- |
| | | | | | | | | | included | | | | | | parative |
| | | | | | | | | | | | | | | | example |
| T′-2 | Li-P-S | 10 | P-2 | 2 | Graphite | 36 | Not | 0 | Not | 0 | Heptane | 41.6 | Toluene | 10.4 | Com- |
| | | | | | | | included | | included | | | | | | parative |
| | | | | | | | | | | | | | | | example |
| T′-3 | LLT | 45 | P-1 | 7 | Not | 0 | Not | 0 | Not | 0 | Octane | 43.2 | Toluene | 4.8 | Com- |
| | | | | | included | | included | | included | | | | | | parative |
| | | | | | | | | | | | | | | | example |
| T'-4 | Li-P-S | 10 | P-18 | 2 | NMC | 36 | AB | 2 | Not | 0 | Heptane | 40 | Octane | 10 | Com- |
| | | | | | | | | | included | | | | | | parative |
| | | | | | | | | | | | | | | | example |
| T′-5 | Li-P-S | 10 | T-1 | 2 | Graphite | 36 | Not | 0 | Not | 0 | Heptane | 41.6 | Isopropyl | 10.4 | Com- |
| | | | | | | | included | | included | | | | isobutyrate | | parative |
| | | | | | | | | | | | | | | | example |
| T′-6 | Li-P-S | 10 | T-2 | 2 | Graphite | 36 | Not | 0 | Not | 0 | Heptane | 41.6 | Isopropyl | 10.4 | Com- |
| | | | | | | | included | | included | | | | methane- | | parative |
| | | | | | | | | | | | | | sulfonate | | example |

<Notes of table>
(A): Inorganic solid electrolyte
LLT: Li_{0.33}La_{0.55}TiO₃ (average particle diameter: 3.25 μm, manufactured by Toshima Manufacturing Co., Ltd.)
Li-P-S: Li-P-S-based glass synthesized above
(B): Binder
P-1 to P-17: Binders P-1 to P-17 described above
T-1: Hydrogenated styrene-butadiene rubber (HSBR, manufactured by JSR Corporation)
T-2: RTV silicone rubber (trade name: KE-1417, manufactured by Shin-Etsu Silicone Co., Ltd.)
(E): Active material
NMC: LiNi_{1/3}Co_{1/3}Mn_{1/3}O₂ (lithium nickel manganese cobalt oxide)
NCA: LiNi_{0.85}Co_{0.10}Al_{0.05}O₂ (lithium nickel cobalt aluminum oxide)
(F): Conductive auxiliary agent
AB: Acetylene black
VGCF: Trade name, carbon nanofiber manufactured by Showa Denko K. K.
(G): Lithium salt
LiTFSI: Lithium bis(trifluoromethanesulfonyl)imide
Parts by mass in Table above indicate parts by mass of the solid content.

<Production of Solid Electrolyte-Containing Sheet>

The solid electrolyte composition S-1 prepared above was coated on stainless steel (SUS) foil, which is a collector, having a thickness of 20 μm serving as a collector by a bar coder. The SUS foil was placed on a hot plate with the SUS foil as the lower surface, heated at 80° C. for 1 hour to remove the dispersion medium and the solvent, and further pressed under pressure at 300 MPa to produce a solid electrolyte-containing sheet No. 101 having a solid electrolyte layer. Solid electrolyte-containing sheets No. 102 to 119 and c11 to c16 were produced in the same manner as in the production of the solid electrolyte-containing sheet No. 101 by using the solid electrolyte compositions of S-2 to S-19 and T′-1 to T′-6 described in Table 2. Here, No. 101 to 119 are examples of the present invention, and No. c11 to c16 are comparative examples. Table 3 shows the thickness of the solid electrolyte layers or the active material layers of the obtained solid electrolyte-containing sheets.

<Evaluation>

The indentation test and the ion conductivity measurement were performed for the solid electrolyte-containing sheets produced above. The test methods are described below, and the results are summarized in Table 3 below.

[Indentation Test]

The obtained solid electrolyte-containing sheet was subjected to an indentation test using a table-top tensile/compression tester MCT2150 (manufactured by A&D Company Ltd.) and a pressure receiving plate (JM-X004-500N, manufactured by A&D Company Ltd.).

The solid electrolyte-containing sheet produced above was punched into a 10 mmφ using a hand punch (manufactured by Nogami-gk Co., Ltd.) and placed on a table of a table-top tensile/compression tester so that the solid electrolyte layer or the active material layer was on the upper side. The pressure receiving plate was lowered at a speed of 1 cm per minute, and the pressure when cracks occurred in the solid electrolyte layer or the active material layer was read and the results were evaluated by the following A to E. An evaluation “D” or a better evaluation than “D” is a pass level of this test.

Evaluation Standards
A: The pressure at which cracks occurred was 15 MPa or more.
B: The pressure at which cracks occurred was 10 MPa or more and less than 15 MPa.
C: The pressure at which cracks occurred was 5 MPa or more and less than 10 MPa.
D: Pressure at which cracks occurred was 1 MPa or more and less than 5 MPa.
E: The pressure at which cracks occurred was 0.5 MPa or more and less than 1 MPa.

(Evaluation of Ion Conductivity)

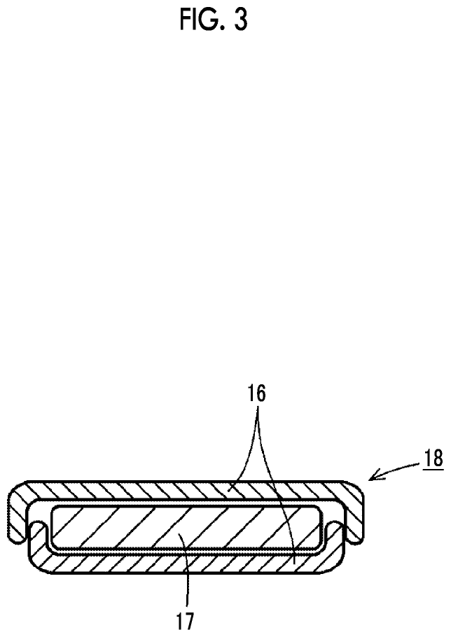

The solid electrolyte-containing sheet obtained above was cut out into two circular sheets having a diameter of 14.5 mm, and an ion conductivity measurement sheet (indicated by a reference sign 15 in FIG. 2 and a reference sign 17 in FIG. 3) to which the application surface (solid electrolyte layer or electrode layer) was attached was integrated with a spacer and a washer (not shown in FIG. 3) and placed in a 2032-type coin case 16 (14 in FIG. 2) made of a stainless steel (a coin-type test specimen for measuring ion conductivity 18 was produced). As shown in FIG. 2, a test specimen for measuring ion conductivity 13 (18 in FIG. 3) for measuring ion conductivity was sandwiched between a lower support plate 12 and an upper support plate 11, a screw S was tightened with a torque wrench at a force of 8 Newtons (N), and test specimens 101 to 119 and c11 to c16 for measuring ion conductivity were produced.

The ion conductivity was measured using each of the test specimens for measuring the ion conductivity obtained above. Specifically, the alternating-current impedance was measured in a constant-temperature tank (30° C.) using a 1255B FREQUENCY RESPONSE ANALYZER (trade name, manufactured by SOLARTRON Analytical) at a voltage magnitude of 5 mV and a frequency of 1 MHz to 1 Hz. Thereby, the resistance in the film thickness direction of the attached solid electrolyte-containing sheet (sample) was determined, and the ion conductivity was calculated by Expression (1).

Ion conductivity σ (mS/cm)=1,000×thickness (cm) of sample film/(resistance (Ω)×sample area (cm²)) Expression (1)

[The thickness of sample film means the thickness of the solid electrolyte layer or the electrode layer.]

Test samples were evaluated to A to E as follows. An evaluation “D” or a better evaluation than “D” is a pass level of this test.

Evaluation Standards
A: 0.70≤σ
B: 0.60≤σ<0.70
C: 0.50≤σ<0.60
D: 0.40≤σ<0.50
E: σ<0.40

TABLE 3

| | Kind of | Kind of solid | Dispersion medium (C) | | Solvent (D) | | | | | |
|---|---|---|---|---|---|---|---|---|---|---|
| | solid | electrolyte- | | Parts | | Parts | Layer | Indentation | Ion | |
| | electrolyte | containing | | by | | by | thickness | test | conductivity | |
| No. | composition | sheet | | mass | | mass | (mm) | evaluation | (mS/cm) | Notes |
| 101 | S-1 | Solid | Octane | 0.08 | Diisopuropyl | 0.16 | 92 | B | A | Present |
| | | electrolyte | | | ketone | | | | | invention |
| | | sheet | | | | | | | | |
| 102 | S-2 | Solid | Octane | 0.08 | Diisopuropyl | 0.19 | 93 | B | A | Present |
| | | electrolyte | | | ketone | | | | | invention |
| | | sheet | | | | | | | | |
| 103 | S-3 | Positive | Heptane | 0.06 | Isopropyl | 0.11 | 93 | A | B | Present |
| | | electrode | | | methanesulfonate | | | | | invention |
| | | sheet | | | | | | | | |
| 104 | S-4 | Negative | Heptane | 0.07 | Isopropyl | 0.13 | 89 | A | C | Present |
| | | electrode | | | methanesulfonate | | | | | invention |
| | | sheet | | | | | | | | |
| 105 | S-5 | Positive | Cyclohexane | 0.08 | Diisobutyl ketone | 0.30 | 93 | B | C | Present |
| | | electrode | | | | | | | | invention |
| | | sheet | | | | | | | | |
| 106 | S-6 | Negative | Cyclohexane | 0.08 | Diisobutyl ketone | 0.26 | 93 | A | A | Present |
| | | electrode | | | | | | | | invention |
| | | sheet | | | | | | | | |
| 107 | S-7 | Positive | Heptane | 0.06 | Propyl butyrate | 0.22 | 87 | B | A | Present |
| | | electrode | | | | | | | | invention |
| | | sheet | | | | | | | | |
| 108 | S-8 | Positive | Heptane | 0.06 | Propyl butyrate | 0.24 | 87 | A | C | Present |
| | | electrode | | | | | | | | invention |
| | | sheet | | | | | | | | |
| 109 | S-9 | Positive | Heptane | 0.07 | Propyl butyrate | 0.20 | 91 | A | B | Present |
| | | electrode | | | | | | | | invention |
| | | sheet | | | | | | | | |
| 110 | S-10 | Positive | Heptane | 0.06 | Fluorinert | 0.09 | 92 | D | C | Present |
| | | electrode | | | | | | | | invention |
| | | sheet | | | | | | | | |
| 111 | S-11 | Positive | Heptane | 0.05 | Fluorinert | 0.05 | 93 | D | D | Present |
| | | electrode | | | | | | | | invention |
| | | sheet | | | | | | | | |
| 112 | S-12 | Positive | Heptane | 0.05 | Fluorinert | 0.05 | 91 | C | C | Present |
| | | electrode | | | | | | | | invention |
| | | sheet | | | | | | | | |
| 113 | S-13 | Negative | Heptane | 0.05 | Dipropyl ether | 0.16 | 89 | B | B | Present |
| | | electrode | | | | | | | | invention |
| | | sheet | | | | | | | | |
| 114 | S-14 | Negative | Heptane | 0.07 | Dipropyl ether | 0.11 | 91 | B | A | Present |
| | | electrode | | | | | | | | invention |
| | | sheet | | | | | | | | |
| 115 | S-15 | Negative | Heptane | 0.04 | Dipropyl ether | 0.20 | 87 | B | A | Present |
| | | electrode | | | | | | | | invention |
| | | sheet | | | | | | | | |
| 116 | S-16 | Positive | Heptane | 0.06 | Methylene | 0.02 | 86 | C | A | Present |
| | | electrode | | | chloride | | | | | invention |
| | | sheet | | | | | | | | |
| 117 | S-17 | Positive | Heptane | 0.06 | Methylene | 0.06 | 90 | C | C | Present |
| | | electrode | | | chloride | | | | | invention |
| | | sheet | | | | | | | | |
| 118 | S-18 | Positive | Heptane | 0.02 | N,N-diisopropyl | 0.24 | 85 | D | B | Present |
| | | electrode | | | ethylene amine | | | | | invention |
| | | sheet | | | | | | | | |
| 119 | S-19 | Positive | Toluene | 0.11 | N,N-diisopropyl | 0.38 | 90 | D | B | Present |
| | | electrode | | | ethylene amine | | | | | invention |
| | | sheet | | | | | | | | |
| c11 | T′-1 | Positive | Heptane | 0.05 | Toluene | 0.16 | 88 | E | E | Comparative |
| | | electrode | | | | | | | | example |
| | | sheet | | | | | | | | |
| c12 | T′-2 | Negative | Heptane | 0.06 | Toluene | 0.19 | 90 | E | E | Comparative |
| | | electrode | | | | | | | | example |
| | | sheet | | | | | | | | |
| c13 | T′-3 | Solid | Octane | 0.09 | Toluene | 0.11 | 93 | E | E | Comparative |
| | | electrolyte | | | | | | | | example |
| | | sheet | | | | | | | | |
| c14 | T'-4 | Positive | Heptane | 0.06 | Octane | 0.10 | 92 | E | E | Comparative |
| | | electrode | | | | | | | | example |
| | | sheet | | | | | | | | |
| c15 | T′-5 | Negative | Heptane | 0.07 | Isopropyl | 0.19 | 89 | E | E | Comparative |
| | | electrode | | | isobutyrate | | | | | example |
| | | sheet | | | | | | | | |
| c16 | T′-6 | Negative | Heptane | 0.04 | Isopropyl | 0.13 | 90 | E | E | Comparative |
| | | electrode | | | methanesulfonate | | | | | example |
| | | sheet | | | | | | | | |

As was clear from Table 3 above, none of the solid electrolyte-containing sheets No. c11 to c16, which contained a binder that did not satisfy the requirements of the present invention or was produced from a solid electrolyte composition containing a solvent that did not satisfy the requirements of the present invention, failed to pass the indentation test and ion conductivity evaluation.

In contrast, all of the solid electrolyte-containing sheets No. 101 to 119 of the embodiment of the present invention produced from the solid electrolyte composition of the embodiment of the present invention passed the indentation test and ion conductivity evaluation.

From the results of the solid electrolyte-containing sheets No. 101 to 119, the solid electrolyte-containing sheet or electrode sheet for an all-solid state secondary battery produced by using the solid electrolyte composition of the embodiment of the present invention has high ion conductivity when used in an all-solid state secondary battery. Furthermore, it can be seen that when the solid electrolyte-containing sheet (solid electrolyte sheet) of the present invention is used as a solid electrolyte layer, an excellent property that short-circuit occurrence can be suppressed can be imparted to an all-solid state secondary battery. In addition, from the excellent results of the indentation test, it can be seen that the solid electrolyte-containing sheet or electrode sheet for an all-solid state secondary battery of the embodiment of the present invention can increase the yield of an all-solid state secondary battery by producing the all-solid state secondary battery using the solid electrolyte composition of the embodiment of the present invention.

### EXPLANATION OF REFERENCES

1: negative electrode collector
2: negative electrode active material layer
3: solid electrolyte layer
4: positive electrode active material layer
5: positive electrode collector
6: operation portion
10: all-solid state secondary battery
11: upper support plate
12: lower support plate
13: test specimen for measuring ion conductivity
14: 2032-type coin case
15: ion conductivity measurement sheet
S: screw
16: 2032-type coin case
17: ion conductivity measurement sheet
18: test specimen for measuring ion conductivity

What is claimed is:

1. A solid electrolyte composition comprising:
an inorganic solid electrolyte (A) having ion conductivity of a metal belonging to Group I or II of the periodic table;
a binder (B);
a dispersion medium (C); and
a solvent (D) having any one of a fluorine atom, an oxygen atom, a nitrogen atom, or a chlorine atom in a chemical structure,
wherein the binder (B) is constituted by a polymer having a partial structure including an acyclic siloxane structure represented by General Formula (I) and a partial structure represented by General Formula (II), 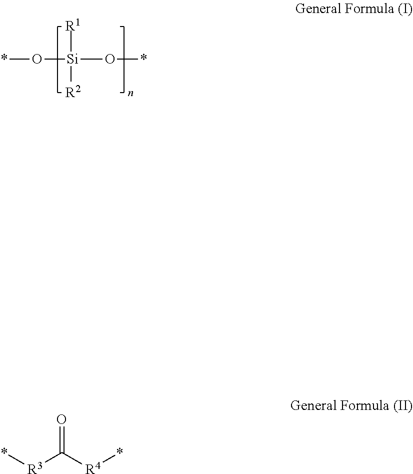
in General Formula (I), R¹ and R² each independently represent a hydrogen atom or a substituent, n represents an integer of 1 or greater, and * represents a bonding portion in the polymer constituting the binder (B), and
in General Formula (II), R³ and R⁴ each independently represent a divalent linking group, and * represents a bonding portion in the polymer constituting the binder (B).

2. The solid electrolyte composition according to claim 1,
wherein a weight-average molecular weight of the partial structure including the acyclic siloxane structure represented by General Formula (I) is 10,000 or less.

3. The solid electrolyte composition according to claim 1,
wherein any one of R¹ or R² in General Formula (I) is a group represented by General Formula (III) or (IV), 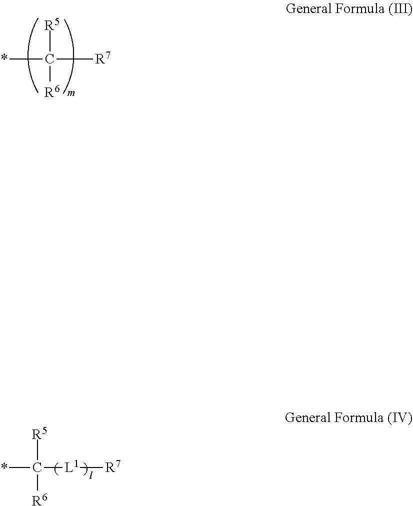
in the formulae, R⁵, R⁶, and R⁷ each independently represent a hydrogen atom or a substituent, m and 1 each independently represent an integer of 1 to 100, L¹ represents a divalent linking group, and * represents a bonding portion in the polymer constituting the binder (B).

4. The solid electrolyte composition according to claim 1,
wherein the polymer constituting the binder (B) includes a partial structure represented by General Formula (V), 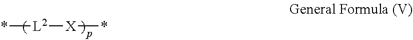
in the formula, L² represents a divalent linking group, X represents any one of —O—, —NR— or —S—, R represents a hydrogen atom or a substituent, p represents an integer of 3 to 300, and * represents a bonding portion in the polymer constituting the binder (B).

5. The solid electrolyte composition according to claim 4,
wherein L² in General Formula (V) is a structure represented by General Formula (VI), 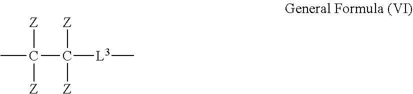
in the formula, Z's each independently represent a hydrogen atom or a substituent, and L³ represents a single bond or a divalent linking group.

6. The solid electrolyte composition according to claim 1,
wherein at least one of R³ or R⁴ in General Formula (II) represents a divalent hetero atom or a divalent linking group including a hetero atom.

7. The solid electrolyte composition according to claim 3,
wherein R⁵ or R⁶ in General Formulae (III) and (IV) is an alkyl group having 5 or fewer carbon atoms.

8. The solid electrolyte composition according to claim 1,
wherein the polymer constituting the binder (B) has at least one group selected from the group consisting of a hydroxy group, a cyano group, an amino group, and a carboxy group.

9. The solid electrolyte composition according to claim 4,
wherein the divalent linking group represented by L² in General Formula (V) has an oxygen atom.

10. The solid electrolyte composition according to claim 1,
wherein the solvent (D) has a carbonyl group or a sulfonyl group.

11. The solid electrolyte composition according to claim 1,
wherein a content of the binder (B) is 0.1 parts by mass or more and 20 parts by mass or less with respect to 100 parts by mass of the inorganic solid electrolyte (A).

12. The solid electrolyte composition according to claim 1, further comprising:
an active material (E).

13. The solid electrolyte composition according to claim 1, further comprising:
a conductive auxiliary agent (F).

14. The solid electrolyte composition according to claim 1,
wherein the inorganic solid electrolyte (A) is a sulfide-based inorganic solid electrolyte.

15. The solid electrolyte composition according to claim 1, further comprising:
a lithium salt (G).

16. A solid electrolyte-containing sheet comprising:
a layer made of the solid electrolyte composition according to claim 1.

17. An all-solid state secondary battery comprising:
a positive electrode active material layer;
a negative electrode active material layer; and
a solid electrolyte layer,
wherein at least one layer of the positive electrode active material layer, the negative electrode active material layer, or the solid electrolyte layer is the solid electrolyte-containing sheet according to claim 16.

18. A method for manufacturing the solid electrolyte-containing sheet comprising:
applying the solid electrolyte composition according to claim 1, onto a base material to form a layer made of the solid electrolyte composition.

19. A method for manufacturing an all-solid state secondary battery, the method comprising:
manufacturing an all-solid state secondary battery through the manufacturing method according to claim 18.
